(19) United States
(12) Patent Application Publication
(10) Pub. No.: US 2006/0132886 A1
(43) Pub. Date: Jun. 22, 2006

(54) Optical device and photographic unit

(75) Inventors: Hideki Kaneiwa, Kanagawa (JP); Ryuji Shinohara, Kanagawa (JP); Atsushi Matsunaga, Kanagawa (JP); Yoshio Ishii, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/285,297

(22) Filed: Nov. 23, 2005

(30) Foreign Application Priority Data
Nov. 25, 2004 (JP) P.2004-340143

(51) Int. Cl. G02F 1/153

(52) U.S. Cl. 359/275

(57) ABSTRACT

An optical device comprises; an electromotive force generating element that generates an electromotive force; and an electrochromic element to be driven by the electromotive force, wherein at the time when the optical device is turned on and an optical density of the electrochromic element becomes constant, a consumed electric current is not more than (power source voltage (V))/5 mA; and a potential between both poles of the electrochromic element 10 seconds after switching the optical device from an ON state to an OFF state is not more than 50% on the basis of a potential between the both poles of the . electrochromic element just before switching.

### BACKGROUND OF THE INVENTION

1. Field of the Invention

The present invention relates to an optical unit having an electromotive force generating element for generating an electromotive force and an electrochromic element to be driven by the subject electromotive force and to a photographic unit equipped with the subject optical device.

2. Description of the Related Art

The application range of elements capable of changing an optical density in response to electromagnetic waves is widespread. Materials capable of changing an optical density, namely materials having a function to be able to control transmission or reflection of light include a photochromic material and an electrochromic material.

The photochromic material as referred to herein is a material whose optical density is changed upon irradiation with light and is applied to sunglasses, ultraviolet checkers, printing-related materials, fiber-processed products, and so on.

The electrochromic material as referred to herein is a material whose optical density is changed upon application of a voltage and is applied to automobile antiglare mirrors, vehicle window materials, and so on.

As applications of such an optical density-changing material, there are enumerated photographic systems including cameras. For example, in recent years, as a camera unit capable of taking pictures, which does not require loading works of a film, a film with lens is widely diffused because of its simplicity. In order to further enhance its utility value, it is performed that a high-speed film is mounted. However, in a conventional film with lens capitalizing on its simplicity, a mechanism for adjusting the exposure amount was not equipped. For that reason, in the case where photographing is performed in a bright atmosphere by using a film with lens having a high-speed film, failure in photographing in which an image becomes white and skips due to its overexposure was often caused. Then, a film with lens into which an AE control system by photometry during photographing is introduced and which is able to automatically switch an aperture stop depending upon the quantity of light for photographing was put on sale. In this way, frequency of failure in photographing due to the overexposure was greatly reduced.

As means for realizing more simply and cheaply a “light control filter” capable of adjusting the quantity of light incident to a photosensitive material depending upon the quality of light for photographing, there is proposed a film with lens using a photochromic material (for example, see JP-A-5-142700, JP-A-6-317815 and JP-A-2001-13301).

As a representative photochromic material, silver halide-containing inorganic compounds, a part of organic compounds and so on are known. Upon irradiation with light at a certain wavelength, such a photochromic material causes coloring, namely increases the optical density. On the other hand, by heating or stopping of light irradiation or upon irradiation with light at a different wavelength, the photochromic material is decolored, namely reduces the optical density. It was thought that it becomes possible to achieve light control by placing a filter made of a photochromic material on its optical axis and performing coloring/decoloring depending upon the quantity of incident light.

However, it is general that the photochromic material requires about one minute for coloring and several tens minutes or longer for decoloring, respectively (for example, see Solid State and Material Science, 1990, Vol. 16, page 291), and it was difficult to use the photochromic material for a light control system of photographing light because of its slow response speed.

In contrast, as a controllable material by application of a voltage, an electrochromic material is known. The electrochromic material is a material in which as a result of the application of a voltage, an electron flows out and in, thereby changing its optical density. As a representative electrochromic material, a part of metal oxides and organic compounds and the like are known. By using such an electrochromic material in combination with a power source and a photo sensor capable of detecting the quantity of photographing light, it becomes possible to realize a “light control filter” capable of adjusting the quantity of light incident to a photosensitive material depending upon the quantity of light during photographing.

There is proposed a light control system comprising a laminate of an electrochromic material and a solar battery capable of generating an electromotive force in response to light (for example, see JP-A-9-244072). In the case of this system, automatic light control depending upon the light can be expected, too. However, in this proposed structure comprising a laminate of a solar battery and an electrochromic material, it is unavoidable that a part of the light which passes through the layer of the electrochromic material is absorbed on the solar battery. In particular, such a structure is improper for a system for utilizing the quantity of light incident to a photographic recording medium at a maximum in a sheet which does not require light control.

On the other hand, it is reported that when en electrochromic material is used by adsorbing on a layer of porous titanium oxide or antimony-doped tin oxide, response speed and memory properties (properties that an element colored by application of a voltage continues to keep coloration even after stopping the application of a voltage) are improved (for example. JP-T-2000-506629, JP-T-2001-510590, Solar Energy Materials and Solar Cells, 1998, Vol. 55, page 215, and Journal of Physical Chemistry B, 2000, Vol. 104, page 11449). It is considered that by improving memory properties of the element, an electric power can be made low in continuing to display an image whose motion is little in, for example, electronic paper.

Then, for the purpose of using an electrochromic material for a light control filter, by connecting an electrochromic element as shown in Journal of Physical Chemistry B, 2000, Vol. 104, page 11449 to a solar battery, coloring/decoloring of the element was changed through ON/OFF of light irradiation to the solar battery. As a result, though the change from a decolored state to a colored state was good, a long period of time was required for the change of the colored state to the decolored state due to the memory properties that the element has. It may be said that while an element having memory properties is suitable for applications such as electronic paper, it does not have suitable properties as a light control filter for photographing.

On the other hand, in using a combination of a solar battery with an electrochromic element, as means for promoting decoloring of the electrochromic element, there is also proposed a method in which a resistor having a low resistivity is used in parallel to the electrochromic element (for example, see JP-A-2-25836 and U.S. Pat. No. 6,055,089).

Then, by connecting an electrochromic element as shown in Journal of Physical Chemistry B, 2000, Vol. 104, page 11449 to a solar battery and connecting a resistor having a low resistivity in parallel to the electrochromic element, coloring/decoloring of the element was changed through ON/OFF of light irradiation to the solar battery. As a result, though the change from a colored state to a decolored state became fast, for the purpose of coloring the electrochromic element, an electric current must be also flown into the parallel resistor separately from the electrochromic element, and therefore, a required area of the solar battery became large.

Furthermore, in U.S. Pat. No. 6,055,089, there is proposed a method in which in using a solar battery, an electrochromic element and a resistor having a low resistivity as connected in parallel to the electrochromic element, a switch is used such that the parallel resistor is not connected in a colored state, while it is connected only in a decolored state. In this case, since an electric current is not required to be flown through the parallel resistor in a colored state, the area of the solar batter can be made equal to that in the case where no parallel resistor is provided. However, in this case, another ON/OFF of a switch separately from ON/OFF of light irradiation to the solar battery is required so that it is impossible to achieve control only by ON/OFF of light irradiation. Accordingly, in this case, it is also difficult to use the material as a light control filter for photographing.

### SUMMARY OF THE INVENTION

An object of the invention is to provide a light control device having a fast speed in both coloring and decoloring and having low consumption of an electric power. Also, the invention is to provide an automatic light control unit using the foregoing light control device and a camera unit mounted with the foregoing automatic light control unit.

The foregoing objects of the invention are achieved by the following optical devices and camera units.

(1) An optical device comprising: an electromotive force generating element that generates an electromotive force; and an electrochromic element to be driven by the electromotive force, wherein at the time when the optical device is turned on and an optical density of the electrochromic element becomes constant, a consumed electric current is not more than (power source voltage (V))/5 mA; and a potential between both poles of the electrochromic element 10 seconds after switching the optical device from an ON state to an OFF state is not more than 50% on the basis of a potential between the both poles of the electrochromic element just before switching.

(2) An optical device comprising: an electromotive force generating element that generates an electromotive force; an electrochromic element to be driven by the electromotive force; and at least one or more resistors as connected in parallel to the electrochromic element, wherein the optical device has a function to adjust a quantity of an electric current which flows thtrough at least one of the resistors depending upon an (ON/OFF) state of the optical device.

(3) An optical device comprising: an electromotive force generating element that generates an electromotive force;

an electrochromic element to be driven by the electromotive force; and one or more resistors connected in parallel to the electrochromic element, wherein the optical device has a function to adjust a quantity of an electric current which flows through at least one of the resistors so as to have a timing at which in said at least one resistor after switching the optical device from an ON state to an OFF state, a larger quantity of an electric current flows in comparison with a value of an amount of the flowing electric current just before switching.

(4) The optical device as set forth above in (2) or (3), wherein at the time when the optical device is turned on and an optical density of the electrochromic element becomes constant, a consumed electric current is not more than (power source voltage (V))/5 mA; and a potential between both poles of the electrochromic element 10 seconds after switching the optical device from an ON state to an OFF state is not more than 50% on the basis of a potential between the both poles of the electrochromic element just before switching,

(5) The optical device as set forth above in any one of (1) to (4), further comprising a transistor.

(6) The optical device as set forth above in any one of (1) to (5), wherein the electromotive force generating element generates an electromotive force in response to electromagnetic waves.

(7) The optical device as set forth above in (6), wherein switching between an ON state and an OFF state is carried out depending upon an intensity of electromagnetic waves to be irradiated to the electromotive force generating element.

(8) The optical device as set forth above in any one of (1) to (7), wherein the electrochromic element comprises a nanoporous semiconductor material including an electrochromic material adsorbed thereto, and the nanoporous semiconductor material has a roughness factor of more than 20.

(9) The optical device as set forth above in any one of (1) to (8), wherein in a decolored state of the electrochromic element, an optical density at a wavelength of 400 nm is 0.2 or less.

(10) The optical device as set forth above in any one of (1) to (9), wherein in a decolored state of the electrochromic element, all of an average value of an optical density at a wavelength of from 400 nm to 500 nm, an average value of an optical density at a wavelength of from 500 nm to 600 nm, and an average value of an optical density at a wavelength of from 600 nm to 700 nm are 0.1 or less.

(11) The optical device as set forth above in any one of (1) to (10), wherein at the time when the optical device is turned on and an optical density of the electrochromic element becomes constant, all of an average value of an optical density at a wavelength of from 450 nm to 470 nm, an average value of an optical density at a wavelength of from 540 nm to 560 nm, and an average value of an optical density at a wavelength of from 630 nm to 650 nm are 0.5 or more.

(12) A photographic unit comprising an optical device as set forth above in any one of (1) to (11).

(13) The photographic unit as set forth above in (12), wherein the photographic unit is a film with lens.

### BRIEF DESCRIPTION OF THE DRAWINGS

FIG. 1 is an outline cross-sectional view to show one representative constructional example of the electrochromic element of the invention;

FIG. 2 is a circuit diagram of the optical device as prepared in Example 1;

FIG. 3 is an electric current-time characteristic graph of each resistor at the time of ON/OFF switching within the optical device as prepared in Example 1;

FIG. 4 is a circuit diagram of the optical device as prepared in Example 2;

FIG. 5 is a circuit diagram of the optical device as prepared in Example 3;

FIG. 6 is an outside view of one example of a film unit with lens having the optical device of the invention;

FIG. 7 is an outline view to show a circuit example of a control device having the optical device of the invention;

FIG. 8 is a graph to show en electromotive force response characteristic of the optical device of the invention as used in Example 5;

FIG. 9 is an outline cross-sectional view of the principal part of an electronic still camera having the optical device of the invention; and

FIG. 10 is an outline outside view of one example of an electronic still camera having the optical device of the invention.

1 denotes a film unit with lens; 4 denotes a photographing lens; 5 denotes a finder; 6 denotes a strobe light-emitting section; 8 denotes a shutter button; 13 denotes a phototransistor; 16 denotes a photographic film; 18 denotes a light shielding cylinder; 20 denotes a lens holder; 21 denotes an aperture; 22 denotes an exposure opening; 23 denotes a light control filter; 24 denotes an aperture stop; 29 denotes an optical axis; 31 denotes a support; 32 denotes a conductive coating; 33a, 33b denotes a porous material having an electrochromic material adsorbed thereon; 34 denotes an electrolyte; and 35 denotes a spacer.

### DETAILED DESCRIPTION OF THE INVENTION

The invention will be hereunder described in more detail. Incidentally, a variety of measured values in the invention were all measured under a condition at a temperature of 25° C. and a humidity of 50%.

In the invention, the term “optical density” as referred to herein is a value A as calculated according to the following numerical expression (1) when an intensity of incident light to an optical density-changing element is designated as I₀ and an intensity of transmitted light is designated as I_{T}.
A=−log(I_{T}/I₀) Numerical Expression (1):

In the invention, the term “nanoporous material” as referred to herein means a material in which irregularities of a nanometer order are formed on the surface such that more substances can be adsorbed thereon, thereby increasing a surface area. A degree of porosity is expressed by a “roughness factor”. Also, in the invention, the term “roughness factor of nanoporous semi-conductor material” is a proportion of an actually effective surface area of the surface of the corresponding semiconductor material layer to the projected plane. Concretely, it can be measured by using the BET method.

In the invention, the term “decolored state” of the electrochromic element as referred herein means a state that an average optical density of the electrochromic element at a wavelength of from 400 nm to 700 nm is made low as far as possible by, for example, short-circuiting both poles of the electrochromic element.

In the invention, the term “colored state” of the electrochromic element as referred to herein means state that an average optical density of the electrochromic element at a wavelength of from 400 nm to 700 nm is made high as compared with that in the “decolored state” by, for example, applying an appropriate voltage between the poles of the electrochromic element.

In the invention, the term “OFF state” of the optical device as referred to herein means a state of the optical device for changing the electrochromic element present in the optical device to the “decolored state” or making the electrochromic element continue to keep the “decolored state”.

In the invention, the term “ON state” of the optical device as referred to herein means a state of the optical device for changing the electrochromic element present in the optical device to the “colored state” or making the electrochromic element continue to keep the “colored state”.

In the invention, the term “consumed electric current” of the optical device as referred to herein means the quantity of an electric current flowing out from one pole of the electromotive force element present in the optical device.

In the invention, the term “semiconductor material” as referred to herein follows a general definition. For example, according to Butsurigaku Jiten (Physics Dictionary), published by Baifukan Co., Ltd., the “semiconductor material” means a substance having an electric resistivity halfway between a metal and an insulator.

In the invention, the term “adsorption of an electrochromic material on a nanoporous semiconductor material” as referred to herein means a phenomenon wherein the electrochromic material is bound on the surface of the nanoporous semiconductor material due to chemical bonding or physical bonding, and the definition of adsorption follows a general definition. The amount of adsorption of the electrochromic material on the surface of the nanoporous semiconductor can be detected by, for example, a method as described below.

A nanoporous semiconductor material which is considered to have an electrochromic material adsorbed thereon is dipped in a 0.1 M NaOH solution and shaken at 40° C. for 3 hours. The amount of the solution to be used herein is determined depending upon the amount of coating of the nanoporous semiconductor material and is properly 0.5 mL per 1 g/m² of the amount of coating. After shaking, an absorption spectrum of the solution is measured by a spectrophotometer. Incidentally, the kind and concentration of the dipping liquid to be used herein (in this case, NaOH) and the temperature and time of shaking are determined depending upon the kinds of the nanoporous semiconductor material and the electrochromic material as used and are not limited to the foregoing numerical values.

In the invention, the term “electromagnetic waves” follows a general definition. For example, according to Butsurigaku Jiten (Physics Dictionary), published by Baifukan Co., Ltd., an electric field and a magnetic field include a static field which is constant in terms of time and a wave field which fluctuates in terms of time and propagates to a far site of the space, and this wave field is defined as electromagnetic waves, Concretely, the electromagnetic waves are classified into γ-rays, X-rays, ultraviolet rays, visible rays, infrared rays, and electric waves. The electromagnetic waves to which the invention is subjective include all of these rays. In the case of the optical device of the invention is applied as a light control system of camera unit, in particular, the subjective waves are preferably ultraviolet rays, visible rays or infrared rays, with visible rays being more preferable.

In the invention, the term “resistor” means a good conductor or semiconductor having a resistivity of not more than 10¹² Ω.

The respective elements of the optical device of the invention will be hereunder described.

In the invention, the term “electromotive force generating element” as referred to herein means a voltage source for supplying an electromotive force for driving the electrochromic element. Though the electromotive generating element is not particularly limited, examples thereof include a dry battery, a lead storage battery, a diesel power generator, a wind power generator, and a solar battery. For example, the dry battery as referred to herein may be any of primary batteries (for example, an alkaline dry battery and a manganese dry battery) and secondary batteries (for example, a nickel-cadmium battery, a nickel-hydrogen battery, and a lithium ion battery).

As the electromotive force generating element of the invention, an electromotive force generating element for generating an electromotive force depending upon electromagnetic waves is preferable. Specific examples thereof include a solar battery. Examples of materials which construct a solar battery include compounds such as monocrystalline silicon, polycrystalline silicon, amorphous silicon, cadmium telluride, and indium copper selenide. Known solar batteries can be selected and used as a solar battery using such a compound depending upon an application of the optical device of the invention.

Furthermore, with respect to a photoelectric transfer element using an oxide semiconductor which is sensitized with a dye (hereinafter abbreviated as “dye-sensitized photoelectric transfer element”) and a photoelectric chemical battery using the same, technologies described in Nature, Vol. 353, pages 737 to 740, 1991, U.S. Pat. No. 4,927,721, JP-A-2002-75443, etc. can be applied as the electromotive force generating element of the invention. Such a dye-sensitized photoelectric transfer element is also preferable as the electromotive force generating element of the invention.

An electromotive force generating element comprising a combination of an electromagnetic sensor and a voltage source is also preferable. In this case, though the electromagnetic wave sensor is not particularly limited, examples thereof include a phototransistor, a CdS sensor, a photodiode, CCD, CMOS, NMOS, and a solar battery. A material of the electromagnetic sensor can be properly selected depending upon the wavelength of electromagnetic waves to be responded. An electromagnetic sensor having high directivity to electromagnetic waves is more preferable as the electromagnetic sensor. The electromagnetic sensor may be the same as an image pickup element. For example, in the case of a digital still camera, CCD, CMOS, and NMOS which are used as the image pickup element can be simultaneously used as the electromagnetic sensor. Though the voltage source is not particularly limited, examples thereof include a dry battery. The dry battery as referred to herein may be any of primary batteries (for example, an alkaline dry battery and a manganese dry battery) and secondary batteries (for example, a nickel-cadmium battery, a nickel-hydrogen battery, and a lithium ion battery).

The electromotive force generating element of the invention is especially preferably a solar batter using, as a raw material, monocrystalline silicon, polycrystalline silicon or amorphous silicon, a dye-sensitized photoelectric transfer element, and a combination of a phototransistor and a dry battery. In the case where the optical device of the invention is applied to a photographic unit (preferably a camera), it is preferable that the electromotive force generating element generates an electromotive force with a size in accordance with the intensity of electromagnetic waves to be irradiated (in particular, sunlight).

In the invention, the term “electrochromic element” as referred to herein means an element for changing an optical density by an electromotive force as generated by the electromotive force generating element, namely electric energy, thereby changing a transmittance of electromagnetic waves.

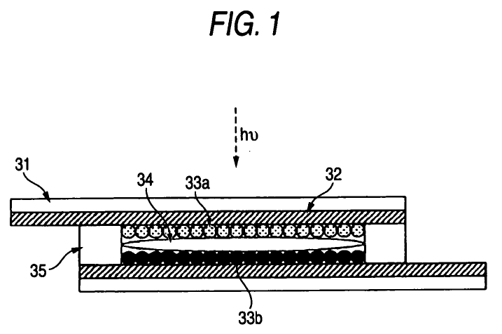

The electrochromic element has a porous material having adsorbed thereon a material capable of changing the optical density depending upon the electric energy (electrochromic material) and is further constructed of a support having a conductive coating carried thereon, a charge transport material for assisting accumulation of a charge in the electrochromic material, and the like. FIG. 1 shows one representative constructional example of the electrochromic element. In FIG. 1, an electrochromic material is adsorbed on each of porous materials (33a, 33b). In each of the electrochromic materials, its optical density is changed depending upon electric energy to be supplied through upper and lower conductive coatings 32 and the porous material 33. In incident electromagnetic waves hv, the amount of transmitted light which is absorbed on the electrochromic material is changed depending upon the change of the optical density of this electrochromic material. The embodiment of the electrochromic element is not limited to the embodiment as shown in FIG. 1, but a variety of embodiments can be taken depending upon the application. Examples thereof include optical filters, lenses, aperture stops, mirrors, windows, spectacles, and display panels. In the photographic unit (preferably a camera), optical filters, lenses, and aperture stops are preferable.

Though the support which constructs the electrochromic element is not particularly limited, examples thereof include glass, plastics, polyethylene terephthalate (PET), polyethylene naphthalate (PEN), triacetyl cellulose (TAC), polycarbonate (PC), polysulfone, polyethersulfone (PES), polyetheretherketone, polyphenylene sulfide, polyarylate (PAR), polyamide, polyimide (PIM), polystyrene, norbornene resins (for example, ARTON), acrylic resins, and polymethyl methacrylate (PMMA). The support can be properly selected depending upon its application and shape. It is preferred to select a support having low absorption against electromagnetic waves to which the optical device of the invention is subjective. Glass, PET, PEN, TAC, and acrylic resins are especially preferable against lights of λ=4.00 nm to 700 μm. In order to avoid a loss of transmitted light due to reflection on the surface of the support, it is also preferred to provide an antireflection layer (for example, a thin layer made of silicon oxide) on the surface of the support. Besides, a variety of functional layers such as an impact absorbing layer for preventing impact against the element, a scratch resistant layer for preventing damages to the element due to friction, and an electromagnetic absorbing layer for cutting electromagnetic waves to which the invention is not subjective (for example, ultraviolet rays in an optical device for visible rays) may be provided. With respect to an ultraviolet absorber and a filter layer having the ultraviolet absorber formed on a transparent support, for example, Compounds (I-1) to (VIII-3) as described in JP-A-2001-147319 are known as the ultraviolet absorber.

Though the conductive coating which constructs the electrochromic element is not particularly limited, examples thereof include thin films of a metal (for example, gold, silver, copper, chromium, palladium, tungsten, and alloys thereof), films of an oxide semiconducto (for example, tin oxide, silver oxide, zinc oxide, vanadium oxide, ITO (indium oxide doped with tin oxide), antimony-doped tin oxide (ATO), FTO (fluorine-doped tin oxide), AZO (aluminum-doped zinc oxide), and GZO (gallium-doped zinc oxide)), thin films of a conductive nitride (for example, titanium nitride, zirconium nitride, and hafnium nitride), thin films of a conductive boride (for example, LaB₆), spinel type compounds (for example, MgInO₄ and CaGaO₄), films of a conductive polymer (for example, polypyrrole/FeCl₃), ionically conductive films (for example, a polyethylene oxide/LiClO₄ film), and inorganic/organic composite films (for example, an indium oxide fine powder/saturated polyester resin film). It is preferred to select a conductive coating having low absorption against electromagnetic waves to which the optical device of the invention is subjective. Tin oxide, FTO, and ITO are especially preferable against lights of λ=400 nm to 700 nm. Furthermore, for the purpose of making the absorption of the subjective electromagnetic waves lower, it is preferable that the electrically conductive layer is as thin as possible so far as desired conductivity can be ensured. Concretely, the thickness of the electrically conductive layer is preferably not more than 1,000 nm, more preferably not more than 200 μm, and especially preferably not more than 100 n.

Though the porous material which constructs the electrochromic element is not particularly limited to the following examples, examples thereof include semiconductor materials made of a metal oxide, a metal sulfide or a metal nitride and metals as described below.

Though the metal oxide is not particularly limited to the following examples, examples thereof include titanium oxide, zinc oxide, silicon oxide, lead oxide, tungsten oxide, tin oxide, indium oxide, niobium oxide, cadmium oxide, bismuth oxide, aluminum oxide, gallium oxide, ferrous oxide, and composite compounds thereof; and materials resulting from doping the foregoing metal oxides with fluorine, chlorine, antimony, phosphorus, arsenic, boron, aluminum, indium, gallium, silicon, germanium, titanium, zirconium, hafnium, tin, etc. Alternatively, materials resulting from coating the surface of titanium oxide by ITO, antimony-doped tin oxide, FTO, etc. may be employed.

Though the metal sulfide is not particularly limited to the following examples, examples thereof include zinc sulfide, cadmium sulfide, and composite compounds thereof; and materials resulting from doping the foregoing metal sulfides with aluminum, gallium, indium, etc. Alternatively, materials resulting from coating the surface of other raw material by a metal sulfide may be employed.

Though the metal nitride is not particularly limited to the following examples, examples thereof include aluminum nitride, gallium nitride, indium nitride, and composite compounds thereof; and materials resulting from doping the foregoing metal nitrides with a small amount of a different kind of atom (for example, tin and germanium). Alternatively, material resulting from coating the surface of other raw material by a metal nitride may be employed. As to the material which is used in the filter portion of the invention, it is preferred to select a porous material having low absorption against electromagnetic waves to which the optical device is subjective. Titanium oxide, tin oxide, zinc oxide, zinc sulfide, and gallium nitride are especially preferable against lights of λ=400 nm to 700 nm. Of these, tin oxide and zinc oxide are especially preferable.

In the invention, by adsorbing an electrochromic material on such a porous material, it is possible to realize smooth flow out and in of an electron for the electrochromic element, thereby changing the optical density of the electrochromic element within a short period of time. On this occasion, when the amount of adsorption of the electrochromic material against the porous material is high, it becomes possible to achieve coloring with a higher density. It is preferable that for the purpose of making it possible to adsorb a larger amount of an electrochromic material, the porous material is made nanoporous, thereby increasing a surface area to have a roughness factor of 20 or more, and especially preferably 150 or more.

Examples of means for forming such a porous material include a method for binding a superfine particle of a nanometer order. In this case, by optimizing the size of the particle to be used and dispersibility of the size, it becomes possible to control a loss of transmitted light as generated due to absorption or scattering of electromagnetic waves by the semiconductor material at minimum levels. The size of the particle to be used is preferably not more than 100 nm, more preferably from 1 nm to 60 nm, and further preferably from 2 nm to 40 nm. Furthermore, it is preferable that the particle size is monodispersed or polydispersed to some extent and that a mixture of monodispersed particles having a different size is used.

In the invention, two or more layers made of such a porous material having an electrochromic material adsorbed thereon may be present. The respective layers of a porous material to be used may be made of the same composition or different compositions. A combination of a porous material having an electrochromic material adsorbed thereon and a porous material not having an electrochromic material adsorbed thereon may be used.

Examples of the electrochromic material which contructs the electrochromic element include organic dyes (for example, viologen based dyes, phenothiazine based dyes, styryl based dyes, ferrocene based dyes, anthraquinone based dyes, pyrazoline based dyes, fluoran based dyes, and phthalocyanine based dyes); conductive polymer compounds (for example, polystyrene, polythiophene, polyaniline, polypyrrole, polybenzine, and polyisothianaphthene); and inorganic compounds (for example, tungsten oxide, iridium oxide, nickel oxide, cobalt oxide, vanadium oxide, molybdenum oxide, titanium oxide, indium oxide, chromium oxide, manganese oxide, Prussian blue, indium nitride, tin nitride, and zirconium nitride chloride).

In the invention, in the case where a specific segment of an organic compound is referred to as “group”, it is meant that the subject segment itself may be unsubstituted or may be substituted with one or more kinds (up to the possible maximum number) of substituents. For example, the term “alkyl group” as referred to herein means a substituted or unsubstituted alkyl group.

When such a substituent is designated as W, the substituent represented by W is not particularly limited. However, examples thereof include a halogen atom, an alkyl group (inclusive of a cycloalkyl group, a bicycloalkyl group, and a tricycloalkyl group), an alkenyl group (inclusive of a cycloalkenyl group and a bicycloalkenyl group), an alkynyl group, an aryl group, a heterocyclic group (which may be called a hetero ring group), a cyano group, a hydroxyl group, a nitro group, a carboxyl group, an alkoxy group, an aryloxy group, a silyloxy group, a heterocyclic oxy group, an acyloxy group, a carbamoyloxy group, an alkoxycarbonyloxy group, an aryloxycarbonyloxy group, an amino group (inclusive of an alkylamino group, an arylamino group, and a heterocyclic amino group), an ammonio group, an acylamino group, an aminocarbonylamino group, an alkoxycarbonylamino group, an aryloxycarbonylamino group, a sulfamoylamino group, an alkyl- or arylaulfonylamino group, a mercapto group, an alkylthio group, an arylthio group, a heterocyclic thio group, a sulfamoyl group, a sulfo group, an alkyl- or arylsulfinyl group, an alkyl- or arylsulfonyl group, an acyl group, an aryloxycarbonyl group, an alkoxycarbonyl group, a carbamoyl group, an aryl- or heterocyclic azo group, an imido group, a phosphino group, a phosphinyl group, a phosphinyloxy group, a phosphinylamino group, a phosphono group, a silyl group, a hydrazino group, a ureido group, a boronic acid group (—B(OH)₂), a phosphato group (—OPO(OH)₂), a sulfato group (—OSO₃H), and other known substituents.

Furthermore, two Ws may be taken together to form a ring (an aromatic or non-aromatic hydrocarbon ring or a heterocyclic ring, and these can be further combined to form a polycyclic fused ring; and examples thereof include a benzene ring, a naphthalene ring, an anthracene ring, a phenanthrene ring, a fluorene ring, a triphenylene ring, a naphthacene ring, a biphenyl ring, a pyrrole ring, a furan ring, a thiophene ring, an imidazole ring, an oxazole ring, a thiazole ring, a pyridine ring, a pyrazine ring, a pyrimidine ring, a pyridazine ring, an indolizine ring, an indole ring, a benzofuran ring, a benzothiophene ring, an isobenzofuran ring, a quinolizine ring, a quinoline ring, a phthalazine ring, a naphthyridine ring, a quinoxaline ring, a quinoxazoline ring, an isoquinoline ring, a carbazole ring, a phenanthridine ring, an acridine ring, a phenanthroline ring, a thianthrene ring, a chromene ring, a xanthene ring, a phenoxathine ring, a phenothiazine ring, and a phenazine ring).

Of the foregoing substituents W, ones having a hydrogen atom may be further substituted with the foregoing group after eliminating the hydrogen atom. Examples of such a substituent include a —CONHSO₂— group (a sulfonylcarbamoyl group or a carbonylsulfamoyl group), a —CONHCO— group (a carbonylcarbamoyl group), and an —SO₂NHSO₂— group (a sulfonylsulfamoyl group). More specifically, there are enumerated an alkylcarbonylaminosulfonyl group (for example, an acetylaminosulfonyl group), an arylcarbonylaminosulfonyl group (for example, a benzoylaminosulfonyl group), an alkylsulfonylaminocarbonyl group (for example, a methylsulfonylaminocarbonyl group), and an arylsulfonylaminocarbonyl group (for example, a p-methylphenylsulfonylaminocarbonyl group).

Examples of the viologen based dye as referred to herein include compounds represented by a structure shown by each of the following general formulae (1), (2) and (3).

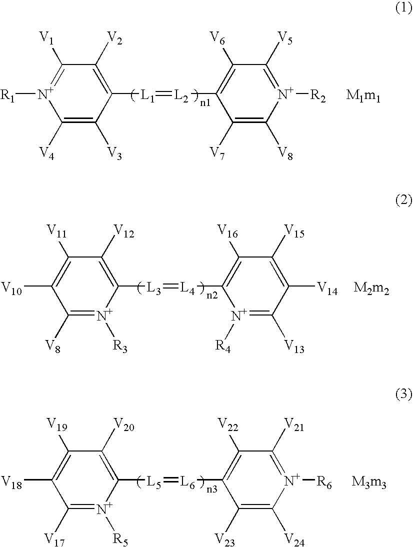

In the general formulae (1), (2) and (3), V₁, V₂, V₃, V₄, V₅, V₆, V₇, V₈, V₉, V₁₀, V₁₁, V₁₂, V₁₃, V₁₄, V₁₅, V₁₆, V₁₇, V₁₈, V₁₉, V₂₀, V₂₁, V₂₂, V₂₃, and V₂₄ each independently represents a hydrogen atom or a monovalent substituent.

R₁, R₂, R₃, R₄, R₅, and R₆ each independently represents a hydrogen atom, an alkyl group, an aryl group, or a heterocyclic group.

L₁, L₂, L₃, L₄, L₅, and L₆ each independently represents a methine group or a nitrogen atom.

n₁, n₂, and n₃ each independently represents 0, 1, or 2.

M₁, M₂, and M₃ each represents independently represents a charge-equilibrated counter ion; and m₁, m₂, and m₃ each independently represents the number of 0 or more necessary for neutralizing the charge of the molecule.

V₁, V₂, V₃, V₄, V₅, V₆, V₇, V₉, V₉, V₁₀, V₁₁, V₁₂, V₁₃, V₁₄, V₁₅, V₁₆, V₁₇, V₁₈, V₁₉, V₂₀, V₂₁, V₂₂, V₂₃, and V₂₄ each independently represents a hydrogen atom or a monovalent substituent; and Vs may be bonded to each other or taken together to form a ring. V may be bonded to other R₁ to R₆ and L₁ to L₆. As the monovalent substituent, the foregoing W is enumerated.

R₁, R₂, R₃, R₄, R₅, and R₆ each independently represents a hydrogen atom, an alkyl group, an aryl group, or a heterocyclic group; preferably an alkyl group, an aryl group, or a heterocyclic group; more preferably an alkyl group or an aryl group; and especially preferably an alkyl group.

Specific examples of the alkyl group, the aryl group and the heterocyclic group represented by R₁ to R₆ include an unsubstituted alkyl group preferably having from 1 to 18 carbon atoms, more preferably from 1 to 7 carbon atoms, and especially preferably from 1 to 4 carbon atoms (for example, methyl, ethyl, propyl, isopropyl, butyl, isobutyl, hexyl, octyl, dodecyl, and octadecyl); and a substituted alkyl group preferably having from 1 to 18 carbon atoms, more preferably from 1 to 7 carbon atoms, and especially preferably from 1 to 4 carbon atoms {For example, an alkyl group having substituted thereon the foregoing W as the substituent. In particular, an alkyl group having an acid group is preferable. The acid group will be described below. The term “acid group” as referred to herein is a dissociable proton-containing group. Specific examples thereof include groups from which a proton is dissociated depending upon the pKa and the pH of the surrounding, such as a sulfo group, a carboxyl group, a sulfato group, a —CONHSO— group (a sulfonylcarbamoyl group or a carbonylsulfamoyl group), a —CONHCO— group (a carbonylcarbamoyl group), an —SO₂NHSO₂— group (a sulfonylsulfamoyl group), a sulfonamide group, a sulfamoyl group, a phosphato group (—OP(═O) (OH)₂), a phosphono group (—P(═O) (OH)₂), a boronic acid group, and a phenolic hydroxyl group. For example, a proton dissociable acid group, 90% or more of which can be dissociated within the pH range of from 5 to 11, is preferable. Of these, a sulfo group, a carboxyl group, a —CONHSO₂— group, a —CONHCO— group, an —SO₂NHSO₂— group, a phosphate group, and a phosphono group are preferable; a carboxyl group, a phosphate group, and a phosphono group are more preferable; a phosphato group and a phosphono group are further preferable; and a phosphono group is the most preferable.

Specifically, preferred examples include an aralkyl group (for example, benzyl, 2-phenylethyl, 2-(4-biphenyl)ethyl, 2-sulfobenzyl, 4-sulfobenzyl, 4-sulfophenethyl, 4-phosphobenzyl, and 4-carboxybenzyl); an unsaturated hydrocarbon group (for example, an allyl group and a vinyl group, that is, the substituted alkyl group as referred to herein includes an alkenyl group and an alkynyl group); a hydroxyalkyl group (for example, 2-hydroxyethyl and 3-hydroxypropyl); a carboxyalkyl group (for example, carboxymethyl, 2-carboxyethyl, 3-carboxylpropyl, and a 4-carboxybutyl); a phosphatoalkyl group (for example, phosphatomethyl, 2-phosphatoethyl, 3-phosphatopropyl, and 4-phosphatobutyl); a phosphonoalkyl group (for example, phosphonomethyl, 2-phosphonoethyl, 3-phosphonopropyl, and 4-phosphonobutyl); an alkoxyalkyl group (for example, 2-methoxyethyl and 2-(2-methoxyethoxy)ethyl); an aryloxyalkyl group (for example, 2-phenoxyethyl, 2-(4-biphenyloxy)ethyl, 2-(1-naphthoxy)ethyl, 2-(4-sulfophenoxy)ethyl, and 2-(2-phosphophenoxy)ethyl); an alkoxycarbonylalkyl group (for example, ethoxycarbonylmethyl and 2-benzyloxycarbonylethyl); an aryloxycarbonylalkyl group (for example, 3-phenoxycarbonylpropyl and 3-sulfophenoxycarbonylpropyl); an acyloxyalkyl group (for example, 2-acetyloxyethyl); an acylalkyl group (for example, 2-acetylethyl); a carbamoylalkyl group (for example, 2-morpholinocarbonylethyl); a sulfamoylalkyl group (for example, N,N-dimethylsulfamoylmethyl); a sulfoalkyl group (for example, 2-sulfoethyl, 3-sulfopropyl, 3-sulfobutyl, 4-sulfobutyl, 2-(3-sulfopropoxy)ethyl, 2-hydroxy-3-sulfopropyl, 3-sulfopropoxyethoxyethyl, 3-phenyl-3-sulfopropyl, 4-phenyl-4-sulfobutyl, and 3-(2-pyridyl)-3-sulfopropyl); a sulfoalkenyl group; a sulfatoalkyl group (for example, 2-sulfatoethyl, 3-sulfatopropyl, and 4-sulfatobutyl); a heterocyclic substituted alkyl group (for example, 2-(pyrrolidin-2-on-1-yl)ethyl, 2-(2-pyridyl)ethyl, tetrahydrofurfuryl, and 3-pyridiniopropyl); an alkylsulfonylcarbamoylalkyl group (for example, a methanesulfonylcarbamoylmethyl group); an acylcarbamoylalkyl group (for example, an acetylcarbamoylmethyl group); an acylsulfamoylalkyl group (for example, an acetylsulfamoylmethyl group); an alkylsulfonylsulfamoylalkyl group (for example, a methanesulfonylsulfamoylmethyl group); an ammonioalkyl group (for example, 3-(trimethylammonio)propyl and 3-ammoniopropyl); an aminoalkyl group (for example, 3-aminopropyl, 3-(di-methylamino) propyl, and 4-(methylamino)butyl); a guanidinoalkyl group (for example, 4-guanidinobutyl)}; a substituted or unsubstituted aryl group preferably having from 6 to 20 carbon atoms, more preferably from 6 to 10 carbon atoms, and especially preferably from 6 to 8 carbon atoms (examples of the substituted aryl group include an aryl group substituted with the foregoing W as enumerated as the substituent; preferably an acid group-containing aryl group, more preferably an aryl group substituted with a carboxyl group, a phosphate group, or a phosphono group, especially preferably an aryl group substituted with a phosphate group or a phosphono group, and most preferably an aryl group substituted with a phosphono group; and specific examples thereof include phenyl, 1-naphthyl, p-methoxyphenyl, p-methylphenyl, p-chlorophenyl, biphenyl, 4-sulfophenyl, 4-sulfonaphthyl, 4-carboxyphenyl, 4-phosphatophenyl, and 4-phosphonophenyl); and a substituted or unsubstituted heterocyclic group preferably having from 1 to 20 carbon atoms, more preferably from 3 to 10 carbon atoms, and especially preferably from 4 to 8 carbon atoms (examples of the substituted heterocyclic group include a heterocyclic group substituted with the foregoing W as enumerated as the substituent; preferably an acid group-containing heterocyclic group, more preferably a heterocyclic group substituted with a carboxyl group, a phosphate group, or a phosphono group, especially preferably a heterocyclic group substituted with a phosphate group or a phosphono group, and most preferably a heterocyclic group substituted with a phosphono group; and specific examples thereof include 2-furyl, 2-thienyl, 2-pyridyl, 3-pyrazolyl, 3-isoxazolyl, 3-isothiazolyl, 2-imidazolyl, 2-oxazolyl, 2-thiazolyl, 2-pyridazyl, 2-pyrimidyl, 2-pyrazyl, 2-(1,3,5-triazoyl), 3-(1,2,4-triazoyl), 5-tetrazolyl, 5-methyl-2-thienyl, 4-methoxy-2-pyridyl, 4-sulfo-2-pyridyl, 4-carboxyl-2-pyridyl, 4-phosphato-2-pyridyl, and 4-phosphono-2-pyridyl).

Furthermore, R may be bonded to other R, V₁ to V₂₄ and L₁ to L₆.

L₁, L₂, L₃, L₄, L₅, and L₆ each independently represents a methine group or a nitrogen atom, and preferably a methine group. The methine group represented by L₁ to L₆ may have a substituent, and as the substituent, the foregoing W is enumerated. Examples thereof include a substituted or unsubstituted alkyl group having from 1 to 15 carbon atoms, preferably from 1 to 10 carbon atoms, and especially preferably from 1 to 5 carbon atoms (for example, methyl, ethyl, 2-carboxyethyl, 2-phosphatoethyl, and 2-phosphonoethyl); a substituted or substituted aryl group having from 6 to 20 carbon atoms, preferably from 6 to 15 carbon atoms, and more preferably from 6 to 10 carbon atoms (for example, phenyl, o-carboxyphenyl, o-phosphatophenyl, and o-phosphonophenyl), a substituted or unsubstituted heterocyclic group having from 3 to 20 carbon atoms, preferably from 4 to 15 carbon atoms, and more preferably from 6 to 10 carbon atoms (for example, an N,N-dimethylbarbituric acid group); a halogen atom (for example, chlorine, bromine, iodine, and fluorine); an alkoxy group having from 1 to 15 carbon atoms, preferably from 1 to 10 carbon atoms, and more preferably from 1 to 5 carbon atoms (for example, methoxy and ethoxy); an amino group having from 0 to 15 carbon atoms, preferably from 2 to 10 carbon atoms, and more preferably from 4 to 10 carbon atoms (for example, methylamino, N,N-dimethylamino, N-methyl-N-phenylamino, and N-methylpiperazino); an alkylthio group having from 1 to 15 carbon atoms, preferably from 1 to 10 carbon atoms, and more preferably from 1 to 5 carbon atoms (for example, methylthio and ethylthio); and an arylthio group having from 6 to 20 carbon atoms, preferably from 6 to 12 carbon atoms, and more preferably from 6 to 10 carbon atoms (for example, phenylthio and p-methylphenylthio). Furthermore, the methine group may be bonded to other methine group to form a ring or may be bonded to V₁ to V₂₄ and L₁ to L₆.

n₁, n₂, and n₃ each independently represents 0, 1, or 2; preferably 0 or 1; and more preferably 0. When n₁ to n₃ each represents 2 or more, though the methine group or the nitrogen atom is repeated, it is not necessary that the methine groups or the nitrogen atoms are the same.

When each of M₁, M₂, and M₃ is necessary for neutralizing an ionic charge of the compound, it is contained for the purpose of showing the presence of a cation or an anion. Typical examples of the cation include inorganic cations (for example, a hydrogen ion (Ht), an alkali metal ion (for example, a sodium ion, a potassium ion, and a lithium ion), and an alkaline earth metal ion (for example, a calcium ion)); and organic ions (for example, an ammonium ion (for example, an ammonium ion, a tetraalkylammonium ion, a triethylammonium ion, a pyridinium ion, an ethylpyridinium ion, and a 1,8-di-azabicyclo[5.4.0]-7-undecenium ion)). The anion may be any of an inorganic anion or an organic anion. Examples thereof include a halogen anion (for example, a fluorine ion, a chlorine ion, and an iodine ion), a substituted arylsulfonic acid ion (for example, a p-toluenesulfonic acid ion and a p-chlorobenzenesulfonic acid ion), an aryldisulfonic acid ion (for example, a 1,3-benzenesulfonic acid ion, a 1,5-naphthalenedisulfonic acid ion, and a 2,6-naphthalenedisulfonic acid ion), an alkylsulfuric acid ion (for example, methylsulfuric acid ion), a sulfuric acid ion, a thiocyanic acid ion, a perchloric acid ion, a tetrafluoroboric acid ion, a picric acid ion, an acetic acid ion, and a trifluoromethanesulfonic acid ion. In addition, other dyes having a reverse charge against the ionic polymer or dye may be used. Furthermore, when CO₂—, SO₃—, and P (═O) (−O⁻)₂ have a hydrogen ion as a counter ion, they can be expressed by CO₂H, SO₃H, and P(═O) (—OH)₂, respectively.

m₁, m₂, and m₃ each represents the number of 0 or more necessary for equilibrating the charge, preferably the number of from 0 to 4, and more preferably the number of from 0 to 2. When a salt is formed within the molecule, m₁, m₂, and m₃ each represents 0.

Specific examples of the viologen based dye will be given below, but it should not be construed that the invention is limited thereto.

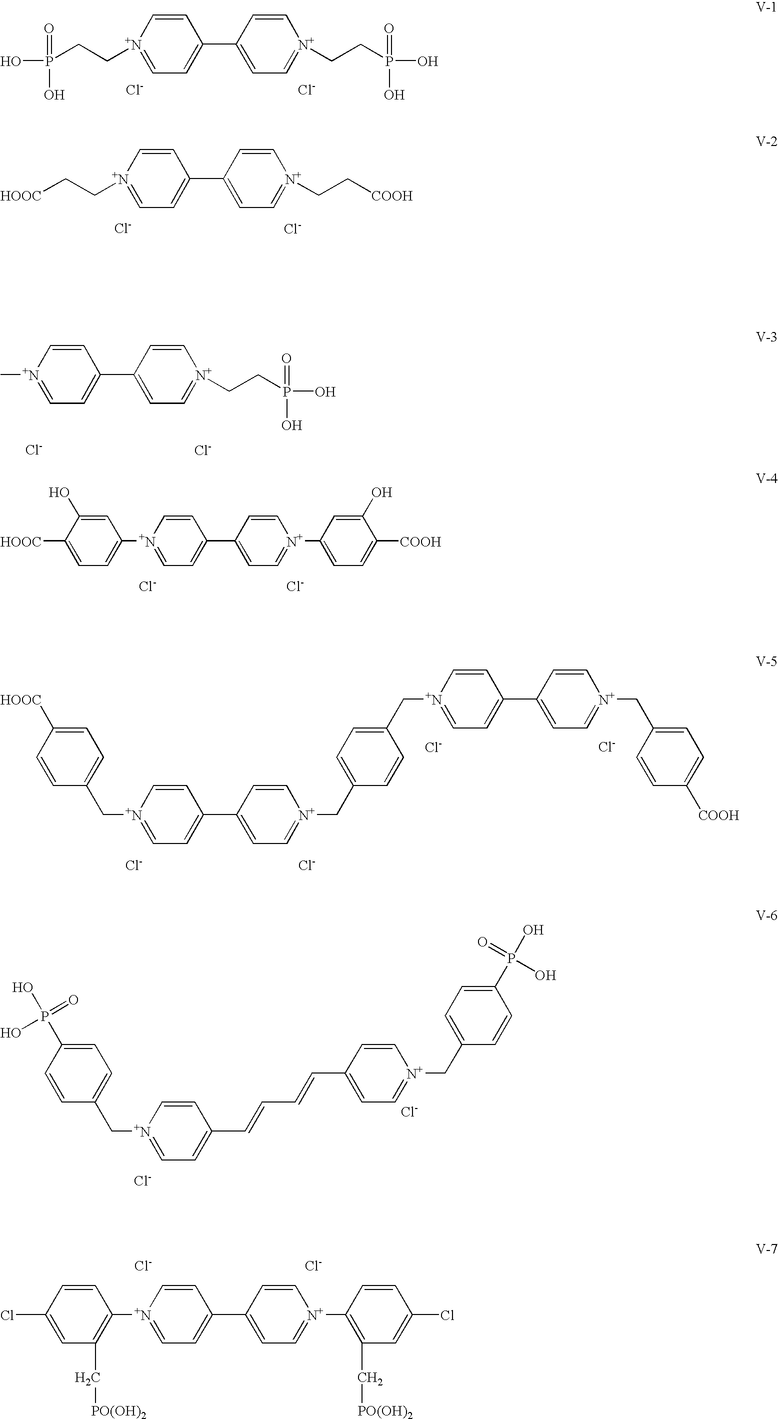

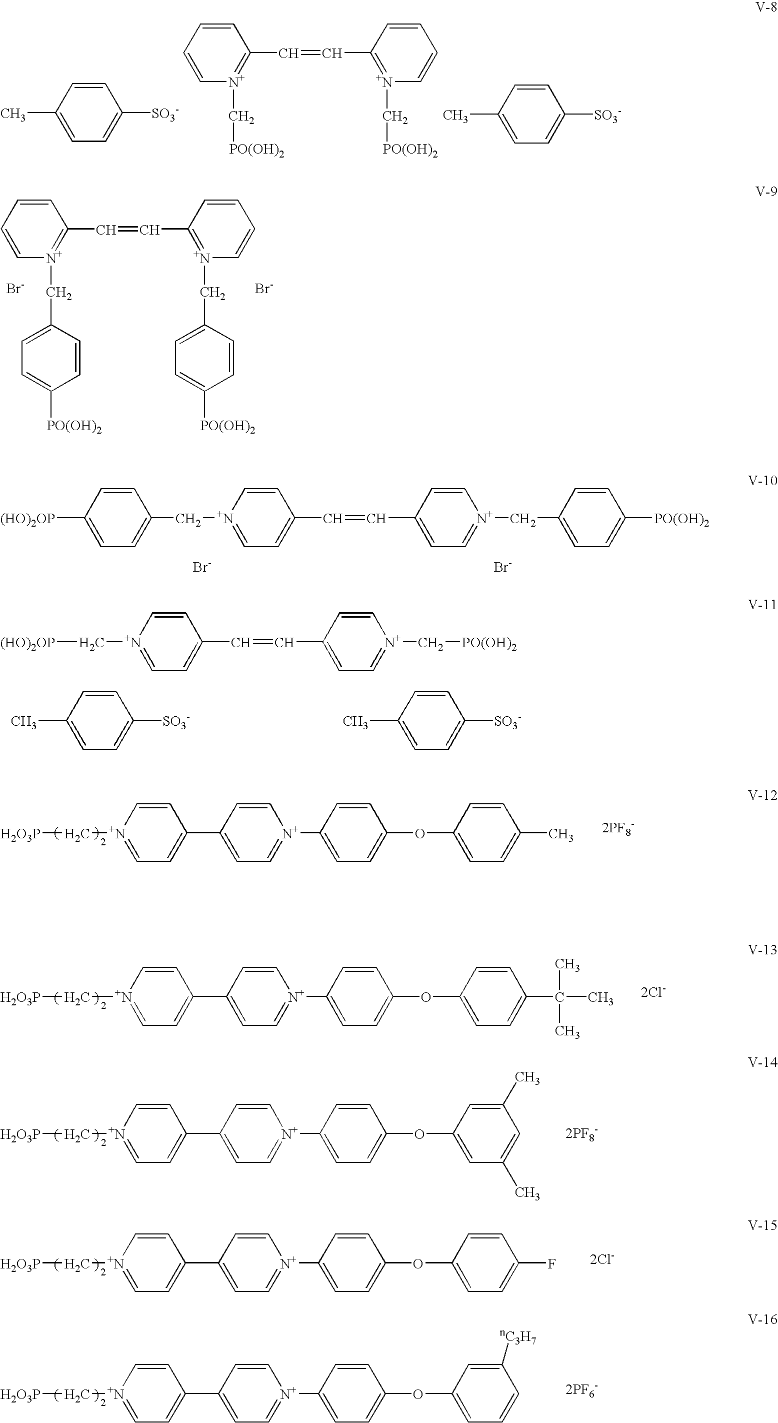

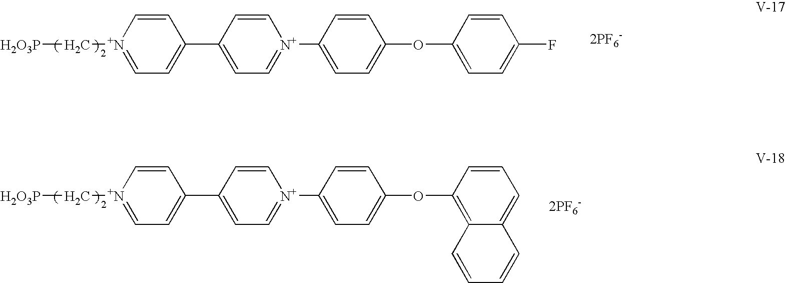

Furthermore, Compounds (1) to (33) as described in claim 4 of WO 2004/067673 are specific examples of the preferred dye. The foregoing viologen based dye is preferably used as the electrochromic material.

The phenothiazine based dye as referred to herein is a compound represented by a structure shown by the following general formula (6).

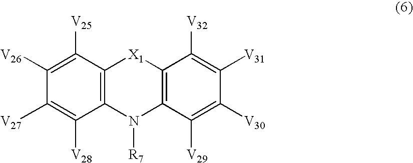

In the general formula (6), V₂₅, V₂₆, V₂₇, V₂₈, V₂₉, V₃₀, V₃₁, and V₃₂ each independently represents a hydrogen atom or a monovalent substituent, and Vs may be bonded to each other or may be taken together to form a ring. Also, V may be bonded to other R₇.

As the monovalent substituent, the foregoing W is enumerated.

R₇ represents a hydrogen atom, an alkyl group, an aryl group, or a heterocyclic group; preferably an alkyl group, an aryl group, or a heterocyclic group; more preferably an alkyl group or an aryl group; and especially preferably an alkyl group. Specific examples of the alkyl group, the aryl group, and the heterocyclic group represented by R₇ include an unsubstituted alkyl group preferably having from 1 to 18 carbon atoms, more preferably from 1 to 7 carbon atoms, and especially preferably from 1 to 4 carbon atoms (for example, methyl, ethyl, propyl, isopropyl, butyl, isobutyl, hexyl, octyl, dodecyl, and octadecyl); a substituted alkyl group preferably having from 1 to 18 carbon atoms, more preferably from 1 to 7 carbon atoms, and especially from 1 to 4 carbon atoms {For example, an alkyl group having substituted thereon the foregoing W as the substituent. In particular, an alkyl group having an acid group is preferable. The acid group has the same meanings as described above in the “alkyl group having an acid group” as in R₁, etc., and specific examples and preferred examples are also the same. specifically, preferred examples include an aralkyl group (for example, benzyl, 2-phenylethyl, 2-(4-biphenyl)ethyl, 2-sulfobenzyl, 4-sulfobenzyl, 4-sulfophenethyl, 4-phosphobenzyl, and 4-carboxybenzyl); an unsaturated hydrocarbon group (for example, an allyl group and a vinyl group, that is, the substituted alkyl group as referred to herein includes an alkenyl group and an alkynyl group); a hydroxyalkyl group (for example, 2-hydroxyethyl and 3-hydroxypropyl); a carboxyalkyl group (for example, carboxymethyl, 2-carboxyethyl, 3-carboxylpropyl, and a 4-carboxybutyl); a phosphatoalkyl group (for example, phosphatomethyl, 2-phosphatoethyl, 3-phosphatopropyl, and 4-phosphatobutyl); a phosphonoalkyl group (for example, phosphonomethyl, 2-phosphonoethyl, 3-phosphonopropyl, and 4-phosphonobutyl); an alkoxyalkyl group (for example, 2-methoxyethyl and 2-(2-methoxyethoxy)ethyl); an aryloxyalkyl group (for example, 2-phenoxyethyl, 2-(4-biphenyloxy)ethyl, 2-(1-naphthoxy)ethyl, 2-(4-sulfophenoxy)ethyl, and 2-(2-phosphophenoxy)ethyl); an alkoxycarbonylalkyl group (for example, ethoxycarbonylmethyl and 2-benzyloxycarbonylethyl); an aryloxycarbonylalkyl group (for example, 3-phenoxycarbonylpropyl and 3-sulfophenoxycarbonylpropyl); an acyloxyalkyl group (for example, 2-acetyloxyethyl); an acylalkyl group (for example, 2-acetylethyl); a carbamoylalkyl group (for example, 2-morpholinocarbonylethyl); a sulfamoylalkyl group (for example, N,N-dimethylsulfamoylmethyl); a sulfoalkyl group (for example, 2-sulfoethyl, 3-sulfopropyl, 3-sulfobutyl, 4-sulfobutyl, 2-(3-sulfopropoxy)ethyl, 2-hydroxy-3-sulfopropyl, 3-sulfopropoxyethoxyethyl, 3-phenyl-3-sulfopropyl, 4-phenyl-4-sulfobutyl, and 3-(2-pyridyl)-3-sulfopropyl); a sulfoalkenyl group; a sulfatoalkyl group (for example, 2-sulfatoethyl, 3-sulfatopropyl, and 4-sulfatobutyl); a heterocyclic substituted alkyl group (for example, 2-(pyrrolidin-2-on-1-yl)ethyl, 2-(2-pyridyl)ethyl, tetrahydrofurfuryl, and 3-pyridiniopropyl); an alkylsulfonylcarbamoylalkyl group (for example, a methanesulfonylcarbamoylmethyl group); an acylcarbamoylalkyl group (for example, an acetylcarbamoylmethyl group); an acylsulfamoylalkyl group (for example, an acetylsulfamoylmethyl group); an alkylsulfonylsulfamoylalkyl group (for example, a methanesulfonylsulfamoylmethyl group); an ammonioalkyl group (for example, 3-(trimethylammonio)propyl and 3-ammoniopropyl); an aminoalkyl group (for example, 3-aminopropyl, 3-(di-methylamino)propyl, and 4-(methylamino)butyl); a guanidinoalkyl group (for example, 4-guanidinobutyl)}; a substituted or unsubstituted aryl group preferably having from 6 to 20 carbon atoms, more preferably from 6 to 10 carbon atoms, and especially preferably from 6 to 8 carbon atoms (examples of the substituted aryl group include an aryl group substituted with the foregoing W as enumerated as the substituent; preferably an acid group-containing aryl group, more preferably an aryl group substituted with a carboxyl group, a phosphate group, or a phosphono group, especially preferably an aryl group substituted with a phosphate group or a phosphono group, and most preferably an aryl group substituted with a phosphono group; and specific examples thereof include phenyl, 1-naphthyl, p-methoxyphenyl, p-methylphenyl, p-chlorophenyl, biphenyl, 4-sulfophenyl, 4-sulfonaphthyl, 4-carboxyphenyl, 4-phosphatophenyl, and 4-phosphonophenyl); and a substituted or unsubstituted heterocyclic group preferably having from 1 to 20 carbon atoms, more preferably from 3 to 10 carbon atoms, and especially preferably from 4 to 8 carbon atoms (examples of the substituted heterocyclic group include a heterocyclic group substituted with the foregoing W enumerated as the substituent; preferably an acid group-containing heterocyclic group, more preferably a heterocyclic group substituted with a carboxyl group, a phosphate group, or a phosphono group, especially preferably a heterocyclic group substituted with a phosphate group or a phosphono group, and most preferably a heterocyclic group substituted with a phosphono group; and specific examples thereof include 2-furyl, 2-thienyl, 2-pyridyl, 3-pyrazolyl, 3-isoxazolyl, 3-isothiazolyl, 2-imidazolyl, 2-oxazolyl, 2-thiazolyl, 2-pyridazyl, 2-pyrimidyl, 2-pyrazyl, 2-(1,3,5-triazoyl), 3-(1,2,4-triazoyl), 5-tetrazolyl, 5-methyl-2-thienyl, 4-methoxy-2-pyridyl, 4-sulfo-2-pyridyl, 4-carboxyl-2-pyridyl, 4-phosphato-2-pyridyl, and 4-phosphono-2-pyridyl).

Furthermore, R₇ may be bonded to V₂₅ to V₃₂.

X₁ represents a sulfur atom, an oxygen atom, a nitrogen atom (N—Ra), a carbon atom (CVaVb), or a selenium atom, and preferably a sulfur atom. Incidentally, Ra represents a hydrogen atom, an alkyl group, an aryl group, or a heterocyclic group; and examples thereof include those as described above for R₁ to R₇, and preferred examples are also the same. Va and Vb each represents a hydrogen atom or a monovalent substituent; and examples thereof include those as described above for V₁ to V₃₂ and R₁ to R₇, and preferred examples are also the same.

Specific examples of the phenothiazine based dye will be given below, but it should not be construed that the invention is limited thereto.

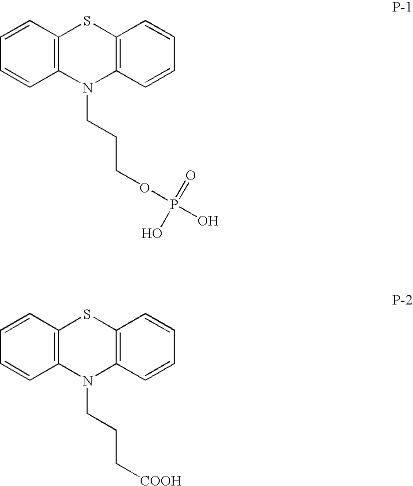

The styryl based dye as referred to herein is a compound having a basic skeleton as shown in the following formula (7).

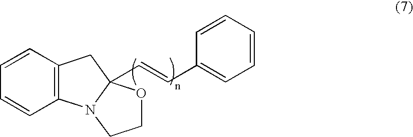

In the formula (7), n represents from 1 to 5. This compound may contain an arbitrary substituent in an arbitrary place in the formula, and in particular, it is preferable that this compound contains an adsorbing substituent such as a carboxyl group, a sulfonic acid group, and a phosphonic acid. Specific examples of the styryl based dye will be given below, but it should not be construed that the invention is limited thereto.

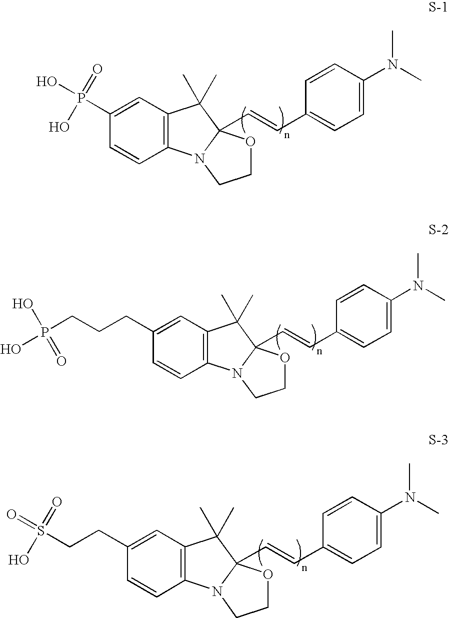

Of these electrochromic materials, with respect to organic compounds, it is possible to control the absorption wavelength by changing a substituent thereof. Furthermore, it is preferable that the optical density-changing element enables the optical density at different wavelengths to change by using two or more kinds of electrochromic materials capable of changing the optical density.

In the case where the optical device of the invention is applied as a light control device such as a photographic unit (preferably a camera), it is preferable that the optical device has an absorption characteristic closed to neutral gray so as to uniformly absorb optical light; that the optical density-changing element absorbs visible rays, preferably plural visible rays having a different wavelength, and more preferably blue rays, green rays and red rays; and that the average values of the optical density as described in the foregoing dissolution means (10) and/or (11) are satisfied. The foregoing dissolution means (10) and/or (11) can be realized by a single material or a combination of plural materials which can give and receive an electron and in which as a result of electron giving and receiving, a spectrum in the wavelength range of from 400 nm to 700 nm is changed. As the material which is used singly, a viologen based dye is preferable. Preferred examples of the combination of two or more kinds of dyes include a combination of a viologen based dye and a phenothiazine based dye, a combination of a viologen based dye and a ferrocene based dye, a combination of a phthalocyanine based dye and Prussian blue, a combination of a viologen based dye and nickel oxide, a combination of a viologen based dye and iridium oxide, a combination of tungsten oxide and a phenothiazine based dye, a combination of a viologen based dye, a phenothiazine based dye and a styryl based dye, a combination of two kinds of viologen based dyes (two kinds having a different substituent) and a phenothiazine based dye, a combination of two kinds of viologen based dyes (two kinds having a different substituent) and a styryl based dye, and a combination of two kinds of viologen based dyes (two kinds having a different substituent) and nickel oxide.

Furthermore, for the sake of promoting an electrochemical reaction of such an electrochromic material, an auxiliary compound may be present in the electrochromic element. The auxiliary compound may or may not be subjected to oxidation-reduction. In the auxiliary compound, the optical density at λ=400 nm to 700 nm may or may not be changed. The auxiliary compound may be present on the porous material likewise the electrochromic material or may be present in the charge transport material layer, or a layer may be solely formed on the electrically conductive layer. It is preferable that the foregoing auxiliary compound is a material which can give and receive an electron on an anode of the electrochromic element and in which as a result of electron giving and receiving, a spectral absorption spectrum in the wavelength range of from 400 nm to 700 nm is changed.

An electron transport material which constructs the electrochromic element as referred to herein is a material which transports a charge due to ion conductivity and/or electron conductivity and is roughly classified into the following four kinds: [1] a liquid electrolyte (for example, see Kagaku Sosetsu (Review of Chemistry): Material Chemistry of New Type Batteries, edited by The Chemical Society of Japan, No. 49 (2001), page 109, Table 1), [2] a polymer electrolyte (for example, see Kagaku Sosetsu (Review of Chemistry): Material Chemistry of New Type Batteries, edited by The Chemical Society of Japan, No. 49 (2001), page 118, FIG. 8), [3] a solid electrolyte (for example, see Kagaku Sosetsu (Review of Chemistry): Material Chemistry of New Type Batteries, edited by The Chemical Society of Japan, No. 49 (2001), page 123), and [4] a cold molten salt (for example, see Kagaku Sosetsu (Review of Chemistry): Material Chemistry of New Type Batteries, edited by The Chemical Society of Japan, No. 49 (2001), page 129). Since the responsibility of the electrochromic element depends upon the ion conductivity of the constructional electrolyte, the liquid electrolyte [1] having high ion conductivity is preferable as the charge transport material of the electrochromic element. However, from the standpoint of the practical use, it involves a problem that the element structure becomes complicated due to a countermeasure for liquid leakage, etc.

The liquid electrolyte is composed of a solvent and a supporting electrolyte. The supporting electrolyte per se does not at all bring about an electrochemical reaction and acts as a role to enhance the conductivity. As the solvent, ones having polarity are preferable. Concretely, solvents selected from water, an alcohol (for example, methanol and ethanol), a carboxylic acid (for example, acetic acid), acetonitrile, propionitrile, glutaronitrile, adiponitrile, methoxyacetonitrile, dimethylacetamide, methylpyrrolidinone, formamide, N,N-dimethylformamide, dimethyl sulfoxide, di-methoxyethane, propylene carbonate, ethylene carbonate, γ-butyrolactone, tetrahydrofuran, dioxolan, sulfolane, trimethyl phosphate, pyridine, hexamethylenic acid triamide, and polyethylene glycol are used singly or in admixture of two or more kinds thereof.

The supporting electrolyte acts as a charge carrier as an ion in the solvent and is a salt comprising a combination of a readily ionized anion and a cation. Examples of the cation include a metal ion represented by Li⁺, Na⁺, K⁺, Rb⁺, and Cs⁺; and a quaternary ammonium ion represented by a tetrabutylammonium ion. Furthermore, examples of the anion include a halogen ion represented by Cl⁻, Br⁻, I⁻, and F⁻; a sulfuric acid ion; a nitric acid ion; a perchloric acid ion; a tosylate ion; a tetrafluoroboric acid ion; and a hexafluorophosphoric acid ion.

Furthermore, the foregoing auxiliary compound may be present in the liquid electrolyte. By dissolving the auxiliary compound in an electrolytic solution, it becomes possible to control a flat band potential of the semiconductor porous material, thereby promoting an electron giving and receiving reaction. Examples of one capable of making the flat band potential base include t-butylpyridine; and examples of one capable of making the flat band potential noble include Li⁺.

Examples of other electrolytes than the liquid electrolyte include a polymer electrolyte represented by film-like ionically conductive substances such as an ion exchange membrane; a solid electrolyte represented by ionic conductors and superionic conductors; and a cold molten salt represented by LiCl/KCl.

Incidentally, it is possible to control the response speed of the electrochromic element by the quantity of giving and receiving of an electron occurred on the porous material at the time of applying a voltage. The smaller the quantity of giving and receiving of an electron, the faster the response speed is, and the larger the quantity of giving and receiving of an electron, the slower the response speed is. Accordingly, in order to make the response speed fast, it is preferred to design the electrochromic element such that the electron giving and receiving reaction does not occur more than the necessity. Furthermore, it is possible to control the response speed by, for example, the viscosity and thickness of the charge transport material layer.

As the electrochromic element, it is preferable that the optical density at λ=400 nm in a decolored state is not more than 0.2 (preferably not more than 0.125) by properly combining raw materials, namely optimizing the kinds of the support, the electrically conductive layer and the electrochromic material, or by optimizing the kind and particle size of the porous material. Similarly, it is preferable that all of an average value of an optical density at λ=400 nm to 500 nm in a decolored state, an average value of an optical density at λ=500 nm to 600 nm in a decolored state, and an average value of an optical density at λ=600 nm to 700 nm in a decolored state are not more than 0.1.

Furthermore, as the electrochromic element, it is preferable that in a colored state of the subject element, a scatter among an average value of an optical density at a wavelength of from 450 to 470 nm, an average value of an optical density at a wavelength of from 540 to 560 nm, and an average value of an optical density at a wavelength of from 630 to 650 nm (the scatter being a difference between the maximum value and the minimum value of the three average values) is not more than 0.5 (more preferably not more than 0.3, and especially preferably not more than 0.1) in terms of the optical density.

In addition, as the electrochromic element, it is preferable that at the time when the optical device is turned on and an optical density of the electrochromic element becomes constant, all of an average value of an optical density at a wavelength of from 450 nm to 470 nm, an average value of an optical density at a wavelength of from 540 nm to 560 nm, and an average value of an optical density at a wavelength of from 630 nm to 650 nm of the electrochromic element are 0.5 or more, more preferably 0.8 or more, and especially preferably 0.95 or more.

In switching the optical device of the invention from an ON state to an OFF state, it is desired that a potential between both poles of the electrochromic element is reduced rapidly as far as possible. The potential between the both poles and the optical density of the electrochromic element are closely related to each other. In order to make the electrochromic element rapidly closed to a decolored state, it is necessary to rapidly reduce the potential between the both poles of the subject element. It is preferable that a potential between the both poles of the electrochromic element 10 seconds (more preferably 8 seconds, further preferably 5 seconds, and especially preferably 3 seconds) after switching the optical device from an ON state to an OFF state is not more than 50% on the basis of a potential between the both poles of the electrochromic element just before switching.

A resistor which is connected in parallel to the electrochromic element of the invention acts to short circuit the both poles of the electrochromic element in turning off the device, thereby releasing an accumulated charge. As a result, a potential between the both poles of the electrochromic element is rapidly reduced, thereby bringing about an effect for rapidly lowering the concentration of the electrochromic element. When the resistivity of the resistor which is connected in parallel to the electrochromic element is low, the release of a charge can be achieved within a short period of time so that the responsibility of the device in an OFF state becomes satisfactory.

On the other hand, when the optical device of the invention is turned on and an optical density of the electrochromic element becomes constant, it is preferable that a consumed electric current is as small as possible. An increase of the consumed electric current brings about an increase in size of the electromotive force generating element. For example, when a solar battery is used as the electromotive force generating element, in order to meet the increased consumed electric current, a solar battery having a larger area is required. Furthermore, when a dry battery is used as the electromotive force generating element, because of the fact that the quantity of electricity which can be outputted (the product of a voltage by an electric current) is limited, an increase of the consumed electric current brings about a reduction of the life of the dry battery, and therefore, such is not preferable. It is preferable that at the time when the optical device is turned on and an optical density of the electrochromic element becomes constant, a consumed electric current is not more than (power source voltage (V))/5 mA (more preferably not more than (power source voltage (V))/10 mA, and further preferably not more than (power source voltage (V))/50 mA).

In an ON state of the device, when a resistor which is connected in parallel to the electrochromic element is present, since a part of the electric current from the electromotive force generating element flows through the resistor which is connected in parallel to the electrochromic element without flowing through the electrochromic element, a necessity for outputting a larger quantity of an electric current from the electromotive force generating element is caused as compared with the case where only the electrochromic element is connected to the electromotive force generating element. When the resistivity of the resistor which is connected in parallel to the electrochromic element is high, only a low quantity of an electric current which flows through the subject resistor may be required, and only a low quantity of an electric current necessary as the whole of the device may be required.

It is preferable that the optical device of the invention has a function to suppress an electric current flowing in an ON state of the device against the resistor which is connected in parallel to the electrochromic element. By having the subject function, since in an ON state of the device, an electric current which flows through the resistor which is connected in parallel to the electrochromic element but does not flow through the electrochromic element is suppressed, only a low quantity of an electric current necessary as the whole of the device may be required. Thus, a device in which in an OFF state of the device, the both poles of the electrochromic element are short circuited through the resistor which is connected in parallel to the electrochromic element, thereby rapidly releasing an accumulated charge, namely an optical device having a fast response speed in both coloring and decoloring and having low consumption of an electric power, is realized.

So far as the foregoing function is concerned, the resistor which is connected in parallel to the electrochromic element may be changed with respect to the resistivity of the resistor itself, or an electric current to the resistor which is connected in parallel to the electrochromic element may be electronically controlled by mechanical means such as a switch or by using a device such as a diode and a transistor. The subject function is preferably automatically achieved, more preferably achieved by using electronic means, and especially preferably achieved by using a transistor.

Though the transistor of the invention is not particularly limited to ones enumerated below, examples thereof include a bipolar transistor and a field-effect transistor. As a matter of course, a combination of a plurality of these transistors may be used. By using a transistor, it becomes possible to adjust the quantity of an electric current which is flown through the resistor which is connected in parallel to the electrochromic element depending upon a potential between both poles of the electromotive force generating element or both poles of the electrochromic element, or the direction or size of an electric current to be flown therebetween, in its turn depending upon ON/OFF of the device.

The optical device of the invention may be provided via a circuit having a function for amplification, protection, or the like in addition to the foregoing function. Though the protective circuit is not particularly limited to one enumerated below, examples thereof include a circuit in which a Zener diode is connected in parallel to the electrochromic element, thereby preventing the matter that a voltage of a fixed amount or more is applied to the electrochromic element from occurrence.

The optical device of the invention can be adapted to vehicle window materials, display devices, camera-related optical devices, and the like. One application example in which effectiveness of the optical device of the invention can be exhibited is a camera-related optical device. The optical device of the invention can be effectively utilized by means for adjusting the quantity of light in photographic units (preferably cameras) such as a large format or medium format camera, a single-lens reflex camera, a compact camera, a film with lens, a digital camera, a broadcasting camera, a movie film camera, a movie digital camera, a photographic unit (preferably camera) for cellular phone, and an 8-mm movie camera. In particular, a destination of application in which the characteristic features can be exhibited is a simple photographic system which does not require a complicated control mechanism, represented by a film with lens. Other examples in which the characteristic features can be exhibited include digital cameras using, as an image pickup element, CCD and CMOS, and narrowness of the dynamic range of an image pickup element can be compensated.

In the case where the optical device of the invention is mounted on the photographic unit, it is preferable that the electrochromic element is placed on the optical axis of the photographic unit.

Furthermore, in the case where the optical device of the invention is mounted on the photographic unit, it is preferable that an overlap between a hue of the optical density in a colored state of the electrochromic element and a hue of the spectral sensitivity of a photographing recording medium (for example, photosensitive materials, CCD, and CMOS) is large. When the photographic unit is a film with lens, the photographing recording medium as referred to herein means a color negative film as mounted; when the photographic unit is an electronic still camera, the photographing recording medium means CCD or CMOS of the subject electronic camera; and when the photographic unit is a cellular phone with camera, the photographing recording medium means CCD of the subject camera, respectively.

In addition, in the case where the optical device of the invention is mounted on a photographic unit, it is preferable that the optical density in a colored state of the electrochromic element is neutral gray. The term “neutral gray” as referred to herein means that a spectral absorption spectrum in a colored state of the electrochromic state is substantially uniform over the entire region at a wavelength of from 400 to 700 nm (a difference between an average amount of an optical density at a wavelength of from 400 to 700 nm and an optical density at each wavelength is small, and specifically, for example, it falls within the range of 0.1), or among hues of the optical density in a colored state of the subject electrochromic element, a portion overlapping a hue of the spectral sensitivity of the recording medium of the photographic unit is substantially uniform, namely “substantially uniform in the photographic unit”.

As a more characteristic application example of the optical device of the invention, there is enumerated an example in which an electromotive force generating element capable of generating an electromotive force by electromagnetic waves is used as the electromotive force generating element. In the case where an electromotive force generating element capable of generating an electromotive force by electromagnetic waves is combined with an optical density-changing element whose optical density is changed by its electromotive force (electrochromic element), an electromotive force is generated from the electromotive force generating element depending upon the electromagnetic waves, and the optical density of the electrochromic element is changed depending upon the subject electromotive force. Accordingly, the optical device of the invention can be applied as an automatic light control device whose quantity of transmitted light is changed depending upon the intensity of electromagnetic waves.

In mounting the optical density of the invention as an automatic light control device on a photographic unit, a preferred hue is also the same as described previously.

In applying the optical device of the optical device of the invention as a light control device, the most preferred example is a combination of an “electromotive force generating element capable of generating an electromotive force in response to electromagnetic waves” composed of an electromagnetic sensor and a dry battery, an “electrochromic element”, a “resistor which is connected in parallel to the electrochromic element”, and a “function for adjusting an electric current flowing through the resistor which is connected in parallel to the electrochromic element depending on the state (ON/OFF) of the optical device” in which the subject adjusting function electronically automatically acts. At this time, an automatic light control device capable of automatically and rapidly adjusting the quantity of transmitted light depending upon the intensity of electromagnetic waves which the device receives can be realized.

### EXAMPLES

For the purpose of describing the invention in detail, the invention will be hereunder described with reference to the following Examples, but it should not be construed that the invention is limited thereto.

### Example 1

Examples of the optical device of the invention will be described. Details and preparation methods of (1) en electrochromic element and (2) a peripheral circuit will be described in this order.

(1) Electrochromic Element:

An electrochromic element was successively prepared by (i) coating of nanoparticle of tin oxide for cathode, (ii) coating of nanoparticle of tin oxide for anode, (iii) adsorption of chromic dye, and (iv) fabrication of electrochromic element.

(i) Preparation of Nanoporous Electrode of Tin Oxide for Cathode:

Polyethylene glycol (molecular weight: 20,000) was added in an aqueous dispersion of tin oxide having a diameter of about 40 nm and uniformly stirred to prepare a coating solution. An antireflection film-provided transparent glass having a conductive ITO film coated thereon (thickness: 0.7 mm) was used as a coating substrate. The coating solution was uniformly coated on the ITO film of the transparent conductive glass substrate such that the amount of coating of tin oxide was 12 g/m². After coating, the coated glass substrate was baked at 450° C. for 30 minutes to prepare a nanoporous electrode of tin oxide for cathode. The electrode thus prepared by the foregoing measures had a surface roughness factor of about 600.

(ii) Preparation of Nanoporous Electrode of Tin Oxide for Anode

Polyethylene glycol (molecular weight: 20,000) was added in an aqueous dispersion of tin oxide having an average diameter of 5 nm and uniformly stirred to prepare a coating solution. An antireflection film-provided transparent glass having a conductive ITO film coated thereon (thickness: 0.7 mm) was used as a coating substrate. The coating solution was uniformly coated on the ITO film of the transparent conductive glass substrate. After coating, the temperature was raised to 450° C. over 100 minutes, and the coated glass substrate was baked at 450° C. for 30 minutes to remove the polymer. Coating and baking were repeated until the total sum of the amount of coating of tin oxide became 8 g/m². There was thus obtained a nanoporous electrode of tin oxide for anode having a uniform film thickness. The electrode thus prepared by the foregoing measures had a surface roughness factor of about 350.

(iii) Adsorption of Electrochromic Dye:

Chromic dyes V-1 and P-1 were respectively used as a chromic dye. The chromic dye V-1 has properties such that it is reduced at a cathode (minus pole) to cause coloring, and the chromic dye P-1 has properties such that it is oxidized at an anode (plus pole) to cause coloring. By dissolving V-1 in water and P-1 in chloroform, respectively in a concentration of 0.02 moles/L, the nanoporous electrode of tin oxide for cathode as prepared in (i) was dipped in and chemically adsorbed with the V-1 solution, and the nanoporous electrode of tin oxide for anode as prepared in (ii) was dipped in and chemically adsorbed with the P-1 solution. After the chemical adsorption, the respective glasses were rinsed with the respective solvents and further dried in vacuo.

(iv) Fabrication of Electrochromic Element;

The porous electrode of tin oxide for cathode having the V-1 dye adsorbed thereon (hereinafter referred to as “cathode”) and the porous electrode of tin oxide for anode having the P-1 dye adsorbed thereon (hereinafter referred to “anode”) as obtained in (iii) were fabricated such that the respective nanoporous material portions were opposed to each other. A γ-butyrolactone solution having 0.2 moles/L of lithium perchlorate dissolved therein as an electrolyte was injected and sealed in a space between the fabricated electrodes. Incidentally, as the electrolytic solution, one after subjecting to dehydration and deaeration was used. The thus prepared electrochromic element is colored by connecting the cathode and the anode to a minus pole and a plus anode, respectively and decolored by short circuiting the both electrodes. The prepared element exhibited a density of 0.05 in a decolored state at λ=610 nm and a density of 0.90 in a colored state in applying 1.5 V.

(2) Peripheral Circuit:

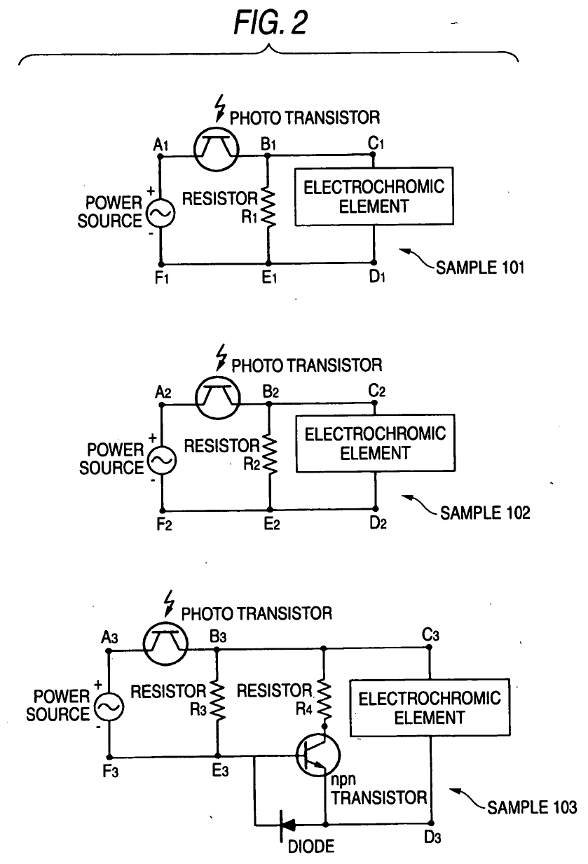

By using the electrochromic element as prepared in (1), Sample 101 (Comparative Example 1), Sample 102 (Comparative Example 2), and Sample 103 (invention) as shown in FIG. 2 were prepared. In the electrochromic element, the anode was connected to each of C₁, C₂ and C₃ sides, and the cathode was connected to each of D₁, D₂ and D₃ sides. A resistivity of each of resistors R₁, R₂, R₃ and R₄ used in the preparation of a circuit is shown in Table 1.

TABLE 1

| Sample No. | Resistor No. | Resistivity |
|---|---|---|
| 101 (Comparative Example 1) | R₁ | 4 kΩ |
| 102 (Comparative Example 2) | R₂ | 150 kΩ |
| 103 (Invention) | R₃ | 150 kΩ |
| | R₄ | 10 kΩ |

As a phototransistor, a product (PT380, manufactured by Sharp Corporation) was commonly used in the respective samples. The ON/OFF operation of the device was carried out by irradiating the surface of the phototransistor with light corresponding to 1,000 lx in a dark room. Each of the samples was adjusted by using a constant voltage power source (PWR18-1.8Q, manufactured by Kenwood Corporation) as a power source so as to apply a voltage of 1.5 V between the both electrodes of the electrochromic element (between C₁ and D₁, between C₂ and D₂, and between C₃ and D₃) such that each of the C₁, C₂ and C₃ sides became plus at the time of turning on the device.

In Sample 103, 2SC1815 as manufactured by Toshiba Semi-conductor Company was used as an npn transistor, and MA165 as manufactured by Matsushita Electric Industrial Co., Ltd. was used as a diode.

A consumed electric current at the time when each of the samples was turned on and an optical density of the electrochromic element became constant is shown in Table 2. Incidentally, the consumed electric current was measured immediately after the plus side of the power source of each of the samples became plus, namely at each of A₁, A₂ and A₃.

TABLE 2

| Sample No. | Consumed electric current |
|---|---|
| 101 (Comparative Example 1) | 0.38 mA |
| 102 (Comparative Example 2) | 0.01 mA |
| 103 (Invention) | 0.01 mA |

It is noted from Table 2 that Sample 101 is larger in the consumed electric current than Samples 102 and 103.

Next, a potential between the both electrodes of the electrochromic element (between C₁ and D₁, between C₂ and D₂, and between C₃ and D₃) after switching each sample from an ON stat to an OFF state at intervals of 2 seconds is shown in Table 3.

TABLE 3

| | Elapsed time | | | | | |
|---|---|---|---|---|---|---|
| | 0 | 2 | 4 | 6 | 8 | 10 |
| Sample No. | second | seconds | seconds | seconds | seconds | seconds |
| 101 | 1.50 V | 0.72 V | 0.66 V | 0.58 V | 0.39 V | 0.20 V |
| (Comparative | | | | | | |
| Example 1) | | | | | | |
| 102 | 1.50 V | 1.17 V | 1.14 V | 1.11 V | 1.09 V | 1.06 V |
| (Comparative | | | | | | |
| Example 2) | | | | | | |
| 103 | 1.50 V | 0.73 V | 0.71 V | 0.67 V | 0.61 V | 0.56 V |
| (Invention) | | | | | | |

It is noted from Table 3 that in Samples 101 and 103, the potential between the electrodes of the electrochromic element can be reduced by half within 2 seconds, while in Sample 102, a large potential still remains even after elapsing for 10 seconds.

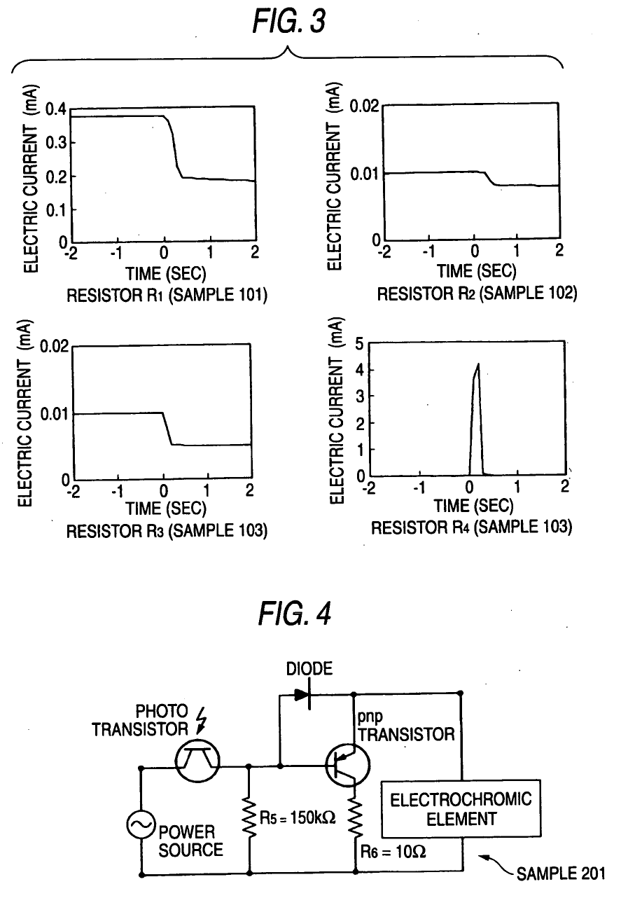

In addition, the size of an electric current flowing through each of the resistors R₁, R₂, R₃ and R₄ before and after switching each sample from an ON state to an OFF state is shown in FIG. 3.

It is noted from FIG. 3 that the resistor R₄ of Sample 103 has a timing when an electric current in a larger quantity as compared with the value of an electric current flowing after switching the sample from an ON state to an OFF state and immediately before switching flows therethrough.

Then, with respect to each of the samples, the presence or absence of its decoloring speed and life was decided. In the decision, on the assumption of using each sample as an automatic light control unit for camera to be driven by a size AAA battery, the decoloring speed was decided on whether or not its time for change by half was within 5 seconds, and the life was decided on whether or not the battery life was durable for 2 years in a state that the sample was allowed to stand outside. Incidentally, in calculating the life, the half of a day was defined to be the daytime, the capacity of the size AAA battery was defined to be 900 mA·h, and a time of consuming the half of the capacity was designated as the life. The results are shown in Table 4.

TABLE 4

| Sample No. | Decoloring speed | Life |
|---|---|---|
| 101 (Comparative Example 1) | Yes | No |
| 102 (Comparative Example 2) | No | Yes |
| 103 (Invention) | Yes | Yes |

It is noted from Table 4 that Sample 103 can realize an excellent device coping with both shortening in the decoloring time and a long life as compared with Samples 101 and 102.

### Example 2

This Example is concerned with a working example in which a pnp transistor was used.

Sample 201 having a circuit as shown in FIG. 4 was prepared by using an electrochromic element the same as that prepared in Example 1. 2SA1015 as manufactured by Toshiba Semiconductor Company was used as a pnp transistor. Besides, the diode, the phototransistor and the power source conformed to those in Sample 103 of Example 1. Sample 201 exhibited a performance conforming to that of Sample 103 of Example 1.

### Example 3

This Example is concerned with a working example in which a field-effect and a dry battery were used.

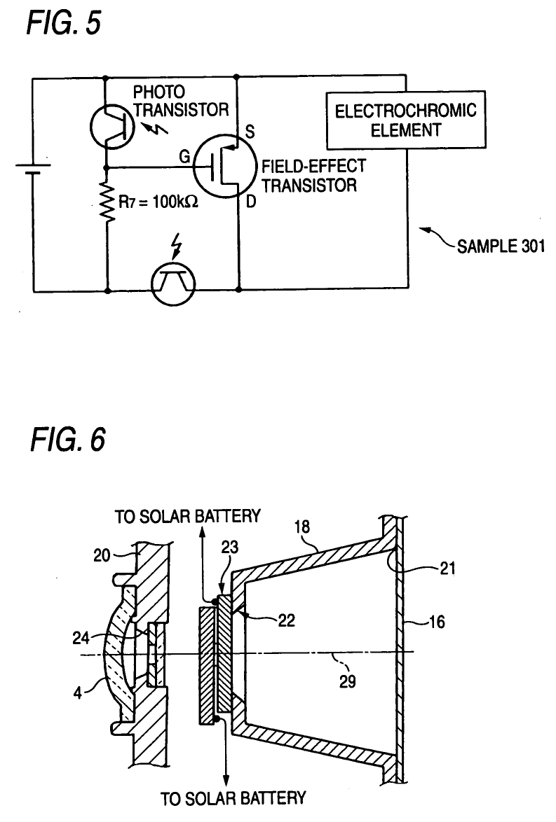

Sample 301 having a circuit as shown in FIG. 5 was prepared by using an electrochromic element the same as that prepared in Example 1. SSM6J51TU as manufactured by Toshiba Semiconductor Company was used as the field-effect transistor, and a commercially available size AAA alkaline battery was used as the dry battery. A phototransistor the same as in Example 1 was used. The thus prepared device exhibited a performance conforming to that of Sample 103 of Example 1.

### Example 4

This Example is concerned with a working example in which a solar battery was used as the electromotive force generating element.

Sample 401 was prepared in the same manner as in Sample 103 of Example 1, except for using a solar battery in place of the constant voltage power source and the phototransistor. Sample 401 exhibited a performance conforming to that of Sample 103 of Example 1.

### Example 5

This Example is concerned with a working example in which the optical device of the invention was mounted on a film unit with lens.

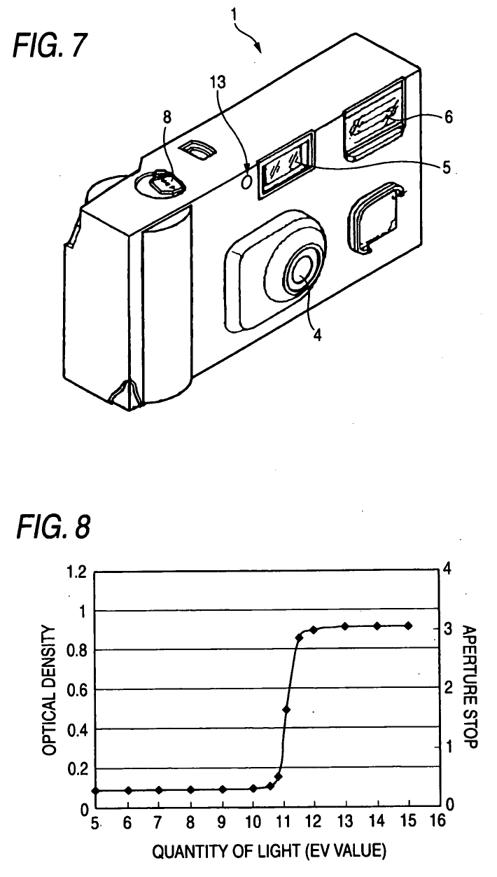

A film unit with lens of the embodiment of this Example is mounted with (1) a light control filter 23 (electrochromic element) and (2) a phototransistor 13 (electromagnetic sensor) as shown in FIGS. 6 and 7. By providing the phototransistor 13 outside the unit, it is possible to generate en electromotive force depending upon the illuminance of external light and to adjust the quantity of light reaching a color negative film 16 by the light control filter 23 as colored by that electromotive force.

An optical device the same as in Example 3 was used in this Example. That is, the electrochromic element was prepared in the same manner as in Example 1, and the circuit as shown in FIG. 5 was incorporated by using this element. On this occasion, a dry battery for strobe (a size AAA battery: 1.5 V) built in the film with lens was used as the electromotive force generating element.

A film with lens having the foregoing device mounted thereon was designated as Sample 502 (invention), and a film with lens not having a device mounted thereon was designated as Sample 501 (comparison). The film as used had an ISO sensitivity of 1, 600, an aperture stop was F8, and a shutter speed was 1/85 seconds. In the case of using a photographic system as constructed under this condition, a negative having an optimum density in photographing a picture under a condition of EV=8.4 is obtained.

TABLE 5

| Sample No. | Automatic light control unit |
|---|---|
| 501 (Comparison) | Not provided |
| 502 (Invention) | Provided (Sample 301 of |
| | Example 3) |

A response characteristic of an optical density of Sample 502 against the intensity of sunlight is shown in FIG. 8. The optical density as shown herein is one at λ=550 nm at which a human being is the most sensitive to light. Table 6 shows to what aperture stop is the respective optical density corresponding in terms of an “aperture stop” to be generally employed in the photographic system. Incidentally, what the aperture stop is set up at “+1” means that the quantity of transmitted light is reduced by half, a value of which is corresponding to an increase of 0.3 in terms of the optical density. As shown in FIG. 8, the aperture stop of this optical device is +0.3 at the time of light shielding, and when light of EV=11.5 was irradiated, the aperture stop increased to +2.8, and when light of EV=12.0 or more was irradiated, the aperture stop increased to +3.0. A response time of the change was 10 seconds. Incidentally, the terms “EV” as referred to herein is a value exhibiting the brightness and is a value which is calculated from a brightness L as expressed using a practical unit lux of illuminance according to the following numerical expression (2).
EV=log₂(L/2.4) Numerical Expression (2):

So far as the relationship with the aperture stop as mentioned previously is concerned, what the aperture stop of a certain optical device is set up at “+1” is corresponding to a reduction of the EV value of brightness of light to be received through the optical device by “1”.

By using each of the foregoing Samples 501 (comparison) and 502 (invention), photographing was carried out at scenes of a brightness in the EV range of from 6.4 (corresponding to the inside of a dark room) to 15.4 (corresponding to the fine weather of midsummer) and subjected to development processing of CN-16 of Fuji Photo Film Co., Ltd. for 3 minutes 15 seconds. As a result, comparison in exposure level of the resulting negatives is shown in Table 6. Incidentally, the term “exposure level” as referred to herein is an evaluation of properness of the density of a negative after the processing, and an optimum density of a negative was designated as “0”. As described previously, in the case of the presently employed photographic system, when a picture is taken under a condition of EV=8.4, a negative having an optimum density is obtained, that is, the exposure level becomes “0”. The exposure level “+1” means that the density is high by an aperture stop of “1” (high by “0.3” in terms of the optical density) from the proper gray density; and the exposure level “−1” means that the density is low by an aperture stop of “1” (low by “0.3” in terms of the optical density) from the proper gray density.

TABLE 6

| | Photographic condition | | | | | | | | | |
|---|---|---|---|---|---|---|---|---|---|---|
| Sample No. | EV = 6.4 | EV = 7.4 | EV = 8.4 | EV = 9.4 | EV = 10.4 | EV = 11.4 | EV = 12.4 | EV = 13.4 | EV = 14.4 | EV = 15.4 |
| 501 | −2.0 | −1.0 | 0 | +1.0 | +2.0 | +3.0 | +4.0 | +5.0 | +6.0 | +7.0 |
| (Comparison) | | | | | | | | | | |
| 502 | −2.3 | −1.3 | −0.3 | +0.7 | +1.7 | +0.4 | +1.0 | +2.0 | +3.0 | +4.0 |
| (Invention) | | | | | | | | | | |

In the case of assuming of performing printing on the basis of a negative as obtained herein, it becomes possible to correct a divergence of the exposure level to some degree. Specifically, in a negative having an exposure level in the range of from −1 to +4, correction can be achieved at the time of printing so that a “picture succeeded in photographing” can be obtained. In the case where the exposure level falls outside the foregoing range, the correction cannot be achieved at the time of printing so that a “failed picture” is obtained. Table 7 shows whether a picture obtained by printing from the negative photographed under the foregoing condition was successful or failed. “S” designates “succeeded”, “F” designates “failed”.

TABLE 7

| | Photographic condition | | | | | | | | | |
|---|---|---|---|---|---|---|---|---|---|---|
| Sample No. | EV = 6.4 | EV = 7.4 | EV = 8.4 | EV = 9.4 | EV = 10.4 | EV = 11.4 | EV = 12.4 | EV = 13.4 | EV = 14.4 | EV = 15.4 |
| 501 | F | S | S | S | S | S | S | F | F | F |
| (Comparison) | | | | | | | | | | |
| 502 | F | F | S | S | S | S | S | S | S | S |
| (Invention) | | | | | | | | | | |

The following can be noted from Table 7. That is, in the case of Sample 502 having a light control system according to the invention, while the region where photographing can be achieved under a low illuminance condition (condition where the EV value is small) was slightly narrowed, the region where photographing can be achieved under a high illuminance condition (condition where the EV value is large) was greatly widened, in comparison with the case of Sample 501 not having a light control system. In other words, by all accounts, a camera system having a wider photographing region is realized.

### Example 6

This Example is concerned with a working example in which in the negative film mounted in the film with lens, the ISO sensitivity was changed from 1, 600 to 100, 400, 1,600 and 3,200, respectively. The results obtained by photographing using a negative film having the respective ISO sensitivity are shown in Table 8. Incidentally, the degree of success of a photographed picture was designated as A, B, C and D in the order of success.

TABLE 8

| | | Presence or | Place for photographing | |
|---|---|---|---|---|
| | ISO | absence of light | | Bright |
| Sample No. | sensitivity | control filter | In dark room | outdoors |
| 601 (Comparison) | 100 | Absent | D | B |
| 602 (Comparison) | 400 | Absent | C | B |
| 603 (Comparison) | 1600 | Absent | B | C |
| 604 (Comparison) | 3200 | Absent | A | D |
| 605 (Invention) | 100 | Present | D | B |
| 606 (Invention) | 400 | Present | C | B |
| 607 (Invention) | 1600 | Present | B | B |
| 608 (Invention) | 3200 | Present | A | B |

The following can be noted from Table 8. That is, of Samples 605 to 608 having a light control system according to the invention, Sample 608 realizes a camera system having an especially wide photographing region. It was noted that the light control filter of the invention most effectively functioned when combined with a negative film having a high sensitivity.

### Example 7

This Example is concerned with a working example in which the electrochromic element of the invention is mounted on a film with lens as described in JP-A-2003-344914. As a result of performing the comparative experiments as in Example 5, in this Example, the electrochromic element of the invention exhibited an excellent light control effect, too.

### Example 8

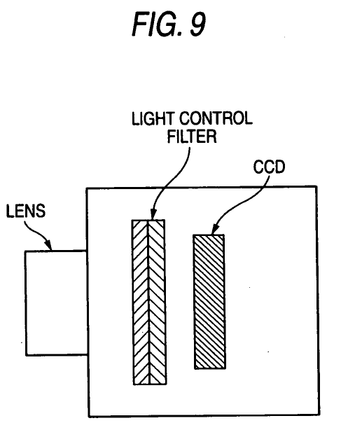

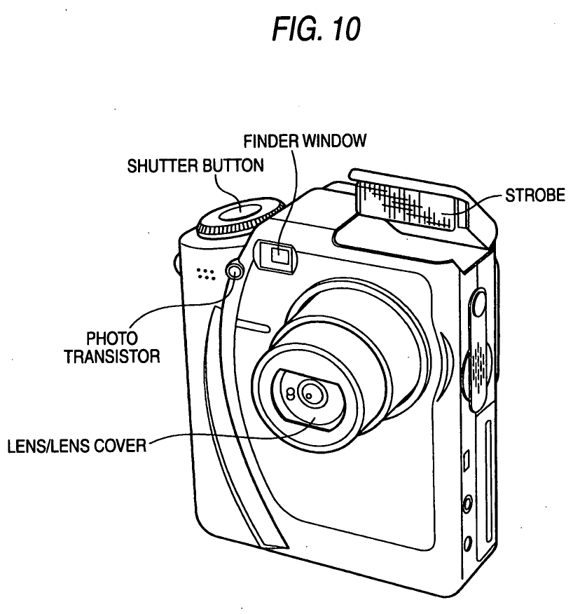

This Example is concerned with a working example in which a light control filter is equipped in an electronic still camera. In the electronic still camera of the invention, as shown in FIG. 9, the electrochromic element 301 as prepared in Example 3 was mounted as a light control filter between a lens and CCD; and as shown in FIG. 10, the same phototransistor as in Example 5 was further installed in the exterior and connected so as to control the light control filter while using, as a power source, a battery built in the electronic still camera. The same comparative experiments as in the film with lens of Example 5 were performed. As a result, in the electronic still camera whose dynamic range is narrow, the invention exhibited a remarkable light control effect as compared with the case of the film with lens.

### Example 9

This Example is concerned with a working example in which the electrochromic element of the invention is mounted on an electronic still camera as described in JP-A-2004-222160. As a result of performing the comparative experiments as in Example 8, in this Example, the electrochromic element of the invention exhibited an excellent light control effect, too.

### Example 10

This Example is concerned with a working example in which the electrochromic element of the invention is mounted on an electronic still camera as described in JP-A-2004-236006. As a result of performing the comparative experiments as in Example 8, in this Example, the electrochromic element of the invention exhibited an excellent light control effect, too.

### Example 11

This Example is concerned with a working example in which the electrochromic element of the invention is mounted on an electronic still camera as described in JP-A-2004-247842. As a result of performing the comparative experiments as in Example 8, in this Example, the electrochromic element of the invention exhibited an excellent light control effect, too.

### Example 12

This Example is concerned with a working example in which the electrochromic element of the invention is mounted on an electronic still camera as described in JP-A-2004-245915. As a result of performing the comparative experiments as in Example 8, in this Example, the electrochromic element of the invention exhibited an excellent light control effect, too.

### Example 13

This Example is concerned with a working example in which a light control filter is installed in a photographic unit for cellular phone. The electrochromic element 301 as prepared in Example 3 was mounted as a light control filter on a lens of a photographic unit for cellular phone; and the same phototransistor as in Example 5 was further installed in the periphery of the photographic unit and connected so as to control the light control filter while using, as a power source, a battery built in the cellular phone. In the case of the cellular phone having mounted thereon the photographic unit of this Example, it was possible to perform photographing under a wider exposure condition in comparison with a photographic unit not having an optical device as in the invention.

### Example 14

This Example is concerned with a working example in which the electrochromic element of the invention is mounted on a cellular phone with camera having a photographing lens as described in JP-A-2004-271991. As a result of performing the comparative experiments as in Example 8, in this Example, the electrochromic element of the invention exhibited an excellent light control effect, too.

According to the invention, in an optical device having an electromotive force generating element and an electrochromic element whose optical density is changed, by providing a resistor which is connected in parallel to the electrochromic element and a mechanism for adjusting the size of an electric current flowing into the subject resistor, it has become possible to realize provision of a light control device having a fast response speed in both coloring and decoloring and having low consumption of an electric power.

The entire disclosure of each and every foreign patent application from which the benefit of foreign priority has been claimed in the present application is incorporated herein by reference, as if fully set forth.

What is claimed is:

1. An optical device comprising:
an electromotive force generating element that generates an electromotive force; and
an electrochromic element to be driven by the electromotive force,
wherein at the time when the optical device is turned on and an optical density of the electrochromic element becomes constant, a consumed electric current is not more than (power source voltage (V))/5 mA; and a potential between both poles of the electrochromic element 10 seconds after switching the optical device from an ON state to an OFF state is not more than 50% on the basis of a potential between the both poles of the electrochromic element just before switching.

2. An optical device comprising:
an electromotive force generating element that generates an electromotive force;
an electrochromic element to be driven by the electromotive force; and
at least one or more resistors as connected in parallel to the electrochromic element,
wherein the optical device has a function to adjust a quantity of an electric current which flows thtrough at least one of the resistors depending upon an (ON/OFF) state of the optical device.

3. An optical device comprising:
an electromotive force generating element that generates an electromotive force;
an electrochromic element to be driven by the electromotive force; and
one or more resistors connected in parallel to the electrochromic element,
wherein the optical device has a function to adjust a quantity of an electric current which flows through at least one of the resistors so as to have a timing at which in said at least one resistor after switching the optical device from an ON state to an OFF state, a larger quantity of an electric current flows in comparison with a value of an amount of the flowing electric current just before switching.

4. The optical device according to claim 2,
wherein at the time when the optical device is turned on and an optical density of the electrochromic element becomes constant, a consumed electric current is not more than (power source voltage (V))/5 mA; and a potential between both poles of the electrochromic element 10 seconds after switching the optical device from an ON state to an OFF state is not more than 50% on the basis of a potential between the both poles of the electrochromic element just before switching.

5. The optical device according to claim 3,
wherein at the time when the optical device is turned on and an optical density of the electrochromic element becomes constant, a consumed electric current is not more than (power source voltage (V))/5 mA; and a potential between both poles of the electrochromic element 10 seconds after switching the optical device from an ON state to an OFF state is not more than 50% on the basis of a potential between the both poles of the electrochromic element just before switching.

6. The optical device according to claim 1, further comprising a transistor.

7. The optical device according to claim 2, further comprising a transistor.

8. The optical device according to claim 3, further comprising a transistor.

9. The optical device according to claim 1,
wherein the electromotive force generating element generates an electromotive force in response to electromagnetic waves.

10. The optical device according to claim 2,
wherein the electromotive force generating element generates an electromotive force in response to electromagnetic waves.

11. The optical device according to claim 3,
wherein the electromotive force generating element generates an electromotive force in response to electromagnetic waves.

12. The optical device according to claim 9,
wherein switching between an ON state and an OFF state is carried out depending upon an intensity of electromagnetic waves to be irradiated to the electromotive force generating element.

13. The optical device according to claim 10,
wherein switching between an ON state and an OFF state is carried out depending upon an intensity of electromagnetic waves to be irradiated to the electromotive force generating element.

14. The optical device according to claim 11,
wherein switching between an ON state and an OFF state is carried out depending upon an intensity of electromagnetic waves to be irradiated to the electromotive force generating element.

15. The optical device according to claim 1,
wherein the electrochromic element comprises a nanoporous semiconductor material including an electrochromic material adsorbed thereto, and the nanoporous semiconductor material has a roughness factor of more than 20.

16. The optical device according to claim 2,
wherein the electrochromic element comprises a nanoporous semiconductor material including an electrochromic material adsorbed thereto, and the nanoporous semiconductor material has a roughness factor of more than 20.

17. The optical device according to claim 3,
wherein the electrochromic element comprises a nanoporous semiconductor material including an electrochromic material adsorbed thereto, and the nanoporous semiconductor material has a roughness factor of more than 20.

18. The optical device according to claim 1,
wherein in a decolored state of the electrochromic element, an optical density at a wavelength of 400 nm is 0.2 or less.

19. The optical device according to claim 2,
wherein in a decolored state of the electrochromic element, an optical density at a wavelength of 400 nm is 0.2 or less.

20. The optical device according to claim 3,
wherein in a decolored state of the electrochromic element, an optical density at a wavelength of 400 nm is 0.2 or less.

21. The optical device according to claim 1,
wherein in a decolored state of the electrochromic element, all of an average value of an optical density at a wavelength of from 400 nm to 500 nm, an average value of an optical density at a wavelength of from 500 nm to 600 nm, and an average value of an optical density at a wavelength of from 600 nm to 700 nm are 0.1 or less.

22. The optical device according to claim 2,
wherein in a decolored state of the electrochromic element, all of an average value of an optical density at a wavelength of from 400 nm to 500 nm, an average value of an optical density at a wavelength of from 500 nm to 600 nm, and an average value of an optical density at a wavelength of from 600 nm to 700 nm are 0.1 or less.

23. The optical device according to claim 3,
wherein in a decolored state of the electrochromic element, all of an average value of an optical density at a wavelength of from 400 nm to 500 nm, an average value of an optical density at a wavelength of from 500 nm to 600 nm, and an average value of an optical density at a wavelength of from 600 nm to 700 nm are 0.1 or less.

24. The optical device according to claim 1,
wherein at the time when the optical device is turned on and an optical density of the electrochromic element becomes constant, all of an average value of an optical density at a wavelength of from 450 nm to 470 nm, an average value of an optical density at a wavelength of from 540 nm to 560 nm, and an average value of an optical density at a wavelength of from 630 nm to 650 nm are 0.5 or more.

25. The optical device according to claim 2,
wherein at the time when the optical device is turned on and an optical density of the electrochromic element becomes constant, all of an average value of an optical density at a wavelength of from 450 nm to 470 nm, an average value of an optical density at a wavelength of from 540 nm to 560 nm, and an average value of an optical density at a wavelength of from 630 nm to 650 nm are 0.5 or more.

26. The optical device according to claim 3,
wherein at the time when the optical device is turned on and an optical density of the electrochromic element becomes constant, all of an average value of an optical density at a wavelength of from 450 nm to 470 nm, an average value of an optical density at a wavelength of from 540 nm to 560 nm, and an average value of an optical density at a wavelength of from 630 nm to 650 nm are 0.5 or more.

27. A photographic unit comprising an optical device according to claim 1.

28. A photographic unit comprising an optical device according to claim 2.

29. A photographic unit comprising an optical device according to claim 3.

30. The photographic unit according to claim 27,
wherein the photographic unit is a film with lens.

31. The photographic unit according to claim 28,
wherein the photographic unit is a film with lens.

32. The photographic unit according to claim 29,
wherein the photographic unit is a film with lens.
